(19) United States
(12) Patent Application Publication
(10) Pub. No.: US 2026/0250199 A1
(43) Pub. Date: Aug. 27, 2026

(54) Methods of Producing a Building Material

(71) Applicant: Blue Planet Systems Corporation, Los Gatos, CA (US)

(72) Inventors: Brent R. Constantz, Portola Valley, CA (US); Jacob Schneider, San Jose, CA (US); Catherine Levey, Palo Alto, CA (US); Seung-Hee Kang, San Jose, CA (US)

(21) Appl. No.: 18/995,339

(22) PCT Filed: Jul. 28, 2023
(86) PCT No.: PCT/US2023/029018

§ 371 Date: Jan. 16, 2025

Related U.S. Application Data
(60) Provisional application No. 63/369,703, filed on Jul. 28, 2022.

(51) Int. Cl. C04B 28/04; C04B 14/28; C04B 111/00

(52) U.S. Cl. CPC C04B 28/04; C04B 14/28; C04B 2111/00019

(57) ABSTRACT

Methods of producing a building material are provided. Methods of interest include preparing a carbonate slurry comprising amorphous calcium carbonate and structural water. Aspects of the invention also include building materials (e.g., aggregates) as well as compositions (e.g., concrete dry composites, settable compositions and built structures) that include building materials produced via the subject methods.

### CROSS-REFERENCE TO RELATED APPLICATION

Pursuant to 35 U.S.C. § 119(e), this application claims priority to the filing date of the U.S. Provisional Patent Application Ser. No. 63/369,703, filed Jul. 28, 2022, the disclosure of which application is herein incorporated by reference.

### INTRODUCTION

Concrete is the most widely used engineering material in the world, due to its ease of placement and high load bearing capacity. It is estimated that the present world consumption of concrete is over 11 billion metric tons per year. (Concrete, Microstructure, Properties and Materials (2006, McGraw-Hill)).

The main ingredients of concrete are cement, such as Portland cement, with the addition of coarse and fine aggregates, air and water. Aggregates in conventional concretes include sand, natural gravel and crushed stone. Artificial aggregates may also be used, especially in lightweight concretes. Once the component materials are mixed together, the mixture sets or hardens due to the chemical process of hydration in which the water reacts with the cement which bonds the aggregates together to form a stone-like material. The proportions of the component materials affect the physical properties of the resultant concrete and, as such, the proportions of mixture components are selected to meet the requirements of a particular application.

Portland cement is made primarily from limestone, certain clay minerals, and gypsum, in a high temperature process that drives off carbon dioxide and chemically combines the primary ingredients into new compounds. The energy required to fire the mixture consumes about 4 GJ per ton of cement produced.

Because carbon dioxide is generated by both the cement production process itself, as well as by energy plants that generate power to run the production process, cement production is a leading source of current carbon dioxide atmospheric emissions. It is estimated that cement plants account for 5% of global emissions of carbon dioxide. As global warming and ocean acidification become an increasing problem and the desire to reduce carbon dioxide gas emissions (a principal cause of global warming) continues, the cement production industry will fall under increased scrutiny.

Fossil fuels that are employed in cement plants include coal, natural gas, oil, used tires, municipal waste, petroleum coke and biofuels. Fuels are also derived from tar sands, oil shale, coal liquids, and coal gasification and biofuels that are made via syngas. Cement plants are a major source of CO₂ emissions, from both the burning of fossil fuels and the CO₂ released from the calcination which changes the limestone, shale and other ingredients to Portland cement. Cement plants also produce waste heat. Additionally, cement plants produce other pollutants like NOx, SOx, VOCs, particulates and mercury. Cement plants also produce cement kiln dust (CKD), which must sometimes be land filled, often in hazardous materials landfill sites.

CO₂ emissions have been identified as a major contributor to the phenomenon of global warming and ocean acidification. CO₂ is a by-product of combustion and it creates operational, economic, and environmental problems. It is expected that elevated atmospheric concentrations of CO₂ and other greenhouse gases will facilitate greater storage of heat within the atmosphere leading to enhanced surface temperatures and rapid climate change. CO₂ has also been interacting with the oceans driving down the pH toward 8.0. CO₂ monitoring has shown atmospheric CO₂ has risen from approximately 280 parts per million (ppm) in the 1950s to approximately 400 ppm today. The impact of climate change will likely be economically expensive and environmentally hazardous. Reducing potential risks of climate change will require sequestration of CO₂.

### SUMMARY

Aspects of the invention include a composition comprising a calcium carbonate solid generated by dewatering calcium carbonate slurry, wherein the calcium carbonate solid contains amorphous calcium carbonate and structural water, and liquid water. In some embodiments, the composition exhibits non-Newtonian behavior.

Methods of interest include preparing a carbonate slurry having amorphous calcium carbonate and structural water, and processing the carbonate slurry under conditions sufficient to produce the building material. In some versions, the carbonate slurry is a slurry of metal carbonate particles (e.g., alkaline earth metal carbonate particles). For example, in some versions, the metal carbonate particles are calcium carbonate particles or calcium magnesium carbonate particles. The polymorph precursors described herein exist in a state between an amorphous state and an ordered state (e.g., amorphous calcium carbonate (ACC) and a polymorph). As such, in some cases, polymorph precursors include vaterite precursor, calcite precursor, and/or aragonite precursor. In some embodiments, methods also include evaluating the carbonate slurry for the presence of the polymorph precursor. Techniques for evaluating a carbonate slurry include, for example, X-ray diffraction (XRD), scanning electron microscopy (SEM), thermogravimetric analysis (TGA), differential scanning calorimetry (DSC), obtaining an infrared (IR) spectrum of the carbonate slurry and obtaining a Ca:C ratio. Embodiments of the invention further include contacting the building material with a curing liquid (e.g., carbonate curing liquid, a bicarbonate curing liquid, a phosphate curing liquid, a divalent alkali earth metal curing liquid or tap water) sufficient to produce a cured building material. Building materials produced via the subject methods include, for example, aggregates.

In some embodiments, preparing the carbonate slurry comprises a CO₂ sequestering process. For example, in certain embodiments, the CO₂ sequestering process comprises contacting an aqueous capture liquid with a gaseous source of CO₂ under conditions sufficient to produce an aqueous carbonate. The method may additionally include combining a cation source and the aqueous carbonate under conditions sufficient to produce a CO₂ sequestering carbonate. In some cases, the aqueous capture liquid is an aqueous ammonia capture liquid. Aspects of the invention also include building materials (e.g., aggregates) as well as compositions (e.g., concrete dry composites, settable compositions and built structures) produced via the subject methods.

### BRIEF DESCRIPTION OF THE FIGURES

The invention may be best understood from the following detailed description when read in conjunction with the accompanying drawings. Included in the drawings is the following figure:

FIG. 1 presents a block diagram of a carbonate composition, according to certain embodiments.

FIG. 2 presents a graph illustrating thermogravimetric analysis (TGA) and differential scanning calorimetry (DSC) of the composition, according to certain embodiments.

FIG. 3 presents a flowchart depicting the production of a finished aggregate that can be used as a building material, in one embodiment, from a carbonate composition, according to certain embodiments.

FIG. 4 presents the characterization, by TGA-DSC, of an example embodiment of the invention wherein the amorphous calcium carbonate (ACC) solid is a pre-aragonite ACC solid. From the analysis, it has been determined that the pre-aragonite ACC solid has a crystallization temperature of 477 degrees C. and is 6.1% structural water by mass, which equates to 0.36 moles of water structurally bound to each mole of calcium carbonate, i.e., a molar ratio of CaCO₃.0.36 H₂O.

FIG. 5 presents the characterization, by TGA-DSC, of an example embodiment of the invention wherein the amorphous calcium carbonate (ACC) solid is a pre-vaterite ACC solid. From the analysis, it has been determined that the pre-vaterite ACC solid has a crystallization temperature of 497 degrees C. and is 3.5% structural water by mass, which equates to 0.20 moles of water structurally bound to each mole of calcium carbonate, i.e., a molar ratio of CaCO₃.0.20 H₂O.

FIG. 6 presents the characterization, by TGA-DSC, of an example embodiment of the invention wherein the amorphous calcium carbonate (ACC) solid is a pre-calcite ACC solid. From the analysis, it has been determined that the pre-calcite ACC solid has a crystallization temperature of 482 degrees C. and is 3.4% structural water by mass, which equates to 0.19 moles of water structurally bound to each mole of calcium carbonate, i.e., a molar ratio of CaCO₃.0.19 H₂O.

FIG. 7 shows, in one embodiment of the invention, the effect pH has on the temperature stability of amorphous calcium carbonate (ACC) solids generated during a CO₂ sequestration process. At pH 8.25, an aliquot of the ACC solid shows two crystallization events at 490 C and at 525 C, as determined by TGA-DSC methods, whereas at pH 7, an aliquot of the ACC solid shows only a single crystallization event at 529 C.

FIG. 8 shows the amount of structurally bound water, on a molar basis, for the ACC solids described in FIG. 7. The ACC solid formed at pH 8.25 has a lower amount of structural-bound water than the ACC solid that formed at pH 7, 0.20 mol H₂O:mol CaCO₃ compared to 0.31 mol H₂O:mol CaCO₃, respectively.

FIG. 9 shows the relative durability of hardened calcium carbonate aggregates prepared from the ACC solids described in FIGS. 7 & 8. Hardened calcium carbonate aggregates prepared from ACC solid formed at pH 7 yielded 98% of the aggregate surviving a durability test, whereas ACC solid formed at pH 8.25 yielded only 20% surviving a durability test method.

FIG. 10 shows an accumulation of data collected from one embodiment of a CO₂ sequestering process, specifically from a gas absorption carbonate precipitation (GACP) process. A correlation is presented, whereby the Supersaturation Trend has an effect on the quality of hardened calcium carbonate aggregates prepared from ACC solids formed at different pHs of the GACP. Here, Supersaturation Trend is proportional to the concentration of calcium ions multiplied by the concentration of dissolved inorganic carbon multiplied by 100. When GACP Solution pH is >8.5, two types of ACC solids were isolated and characterized by TGA-DSC methods, one with a crystallization event at 520° C. and the other with a crystallization event at 490° C.; this combination of ACC solids led to poor quality hardened calcium carbonate aggregate, as was determined by a durability test method analogous to that described in connection with FIG. 8, and the region is described as a “Bad” precipitation environment. Likewise, in the pH range of 8.5 to 8.0, the same two types of ACC solids were identified, yielding improved, but variable quality hardened calcium carbonate aggregate in a region described as a High variance region. Conversely, in the pH range below 8.0, only the ACC solid with a crystallization event at 520° C. was identified, and it yielded good quality hardened calcium carbonate in a region described as a “Good” precipitation environment. The absence of ACC solid with a crystallization event at 490° C. in the “Good” precipitation environment region led to produced aggregates with desirable hardness qualities.

FIG. 11 shows data from shear rate sweep tests comparing the rheological properties of an amorphous calcium carbonate (ACC) solid to a calcium carbonate solid without ACC, prepared using one embodiment of a CO₂ sequestering process. The ACC solid has constant stress during the shear sweep and is linearly shear thinning. Conversely, the calcium carbonate solid without ACC has increasing stress during the shear sweep test, and is also shear thinning. Note that results are from different geometries with less-than-ideal sample loading; values are not exact.

### DETAILED DESCRIPTION

Aspects of the invention include a composition comprising a calcium carbonate solid generated by dewatering calcium carbonate slurry, wherein the calcium carbonate solid contains amorphous calcium carbonate and structural water, and liquid water. In some embodiments, the composition exhibits non-Newtonian behavior. Aspects of the invention also include building materials (e.g., aggregates) as well as compositions (e.g., concrete dry composites, settable compositions and built structures) that include building materials produced via the subject methods.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating un-recited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates, which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

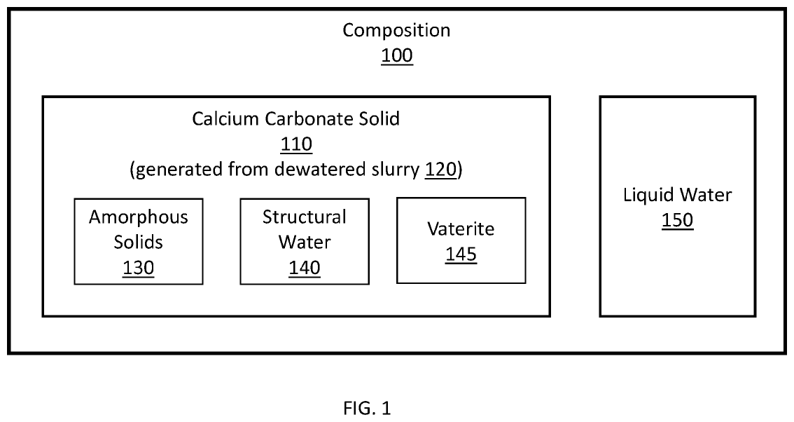

As discussed above, aspects of the invention include methods of producing a building material. Methods of interest include preparing a composition (also referred to as a “slurry cake” herein), such as composition 100 (FIG. 1). Composition 100 comprises a calcium carbonate solid 110 generated by dewatering calcium carbonate slurry 120 and liquid water 150. In some embodiments, there may be little to no liquid water 150 (not shown). In some embodiments, the composition 100 comprises from 45 wt % to 75 wt % calcium carbonate solid 110. In some embodiments, the composition 100 comprises about 65 wt % calcium carbonate solid 110. In some embodiments, the calcium carbonate solid 110 contains amorphous calcium carbonate 130, structural water 140, and vaterite 145. In some embodiments, the calcium carbonate solid 110 comprises from 1 wt % to 100 wt % amorphous calcium carbonate solid 130. In some embodiments, the calcium carbonate solid 110 comprises from 3 wt % to 10 wt % structural water 140.

In some embodiments, the composition 100 exhibits non-Newtonian behavior. Accordingly, the composition 100 can behave as a solid or as a liquid depending on the force or agitation that has been applied. In some embodiments, the composition 100 exhibits the following behavior:
behaves as a dry solid upon being filtered;
releases at least a portion of its water upon application of mechanical agitation. Accordingly, when the slurry cake is agitated, such as when shear (mixing), or shaking, or blunt force is applied and released many times, it releases at least some of its structural water. As discussed further below, in some embodiments, release of water may be caused by mineralogical conversion of at least some of the amorphous calcium carbonate to one or more other calcium carbonate mineral polymorphs, such as mineralogical conversion of hydrous ACC to anhydrous phases. Accordingly, in some embodiments, slurries seem dry when freshly prepared, but they tend to become more watery and wet at the surface as the hydrous ACC solids transform into anhydrous solids, e.g., vaterite, because the water, which in some instances may be all or partially structural water, becomes released as they transform into anhydrous CaCO₃;
upon the release of water, e.g., during a dewatering process, e.g., such as filtration, drying, or dehydration, amorphous calcium carbonate (ACC) solid transforms into a crystalline calcium carbonate solid, which may be a paste or other flowable composition. In some embodiments, the calcium carbonate solid has a visco-elastic consistency. In some embodiments, calcium carbonate solid has a liquid to solid ratio of about 0.5, such as being in the range of about 0.4 to about 0.8;
the calcium carbonate solid cures to form hardened calcium carbonate aggregates. In some embodiments, the calcium carbonate hardens without drying to form the hardened calcium carbonate aggregates. In some embodiments, the hardened calcium carbonate aggregates are cohesive when placed in water. In some embodiments, the hardened calcium carbonate aggregates do not fall apart in water. In some embodiments, a pore size of the hardened calcium carbonate aggregates is controlled by controlling the liquid to solid ratio of the calcium carbonate solid.

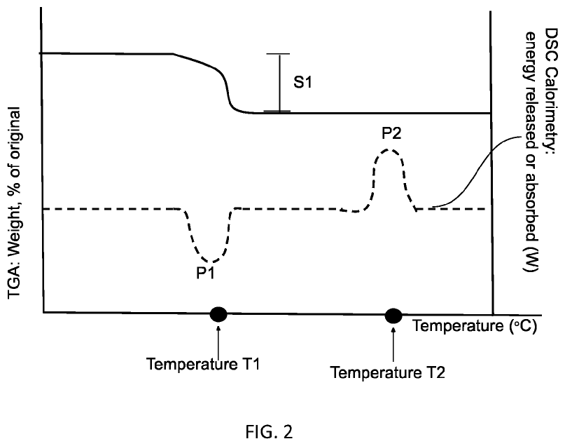

FIG. 2 presents a graph illustrating thermogravimetric analysis and differential scanning calorimetry of the calcium carbonate solid 110, according to certain embodiments.

The dashed line in the graph represents energy released or absorbed and the integral under the curve provides energy of transformation. There are two important peaks in the dashed line. Two pieces of data can be extracted for each peak. At about temperature T1 (in some embodiments 120 degree Celsius (plus or minus about 5 ° Celsius)), structural water 140 is released from calcium carbonate solid 110.

Corresponding to temperature T1, there is a peak P1 in the dashed line that corresponds to structural water 140 being released. In some embodiments, for every molecule of calcium carbonate solid 110, 0.25-0.40 molecules of structural water 140 is released. As the structural water 140 is released, the calcium carbonate solid 110 absorbs energy.

At temperature T2 (in some embodiments 210 degree Celsius (plus or minus about 8° Celsius)), amorphous solids 130 convert to vaterite and/or calcite. In some embodiments, substantially all or even all of the amorphous solids 130 convert to vaterite and/or calcite. Corresponding to temperature T2, there is a peak P2 in the dashed line that corresponds to conversion of amorphous solids 130 to vaterite and/or calcite. As the released water 140 is boiled off, the amorphous solids 130 in the calcium carbonate solid 110 convert to vaterite and/or calcite.

The solid line in the graph represents the thermogravimetric analysis of the calcium carbonate solid 110. Corresponding to peak P1, there is a dip that corresponds to release of the water 140 from calcium carbonate solid 110. When the dip happens (i.e., corresponding to temperature T1) and the size of the dip are important differentiators from other compositions, according to some embodiments. The size of the dip S1 corresponds to an amount of structural water 140 released and is different from other compositions.

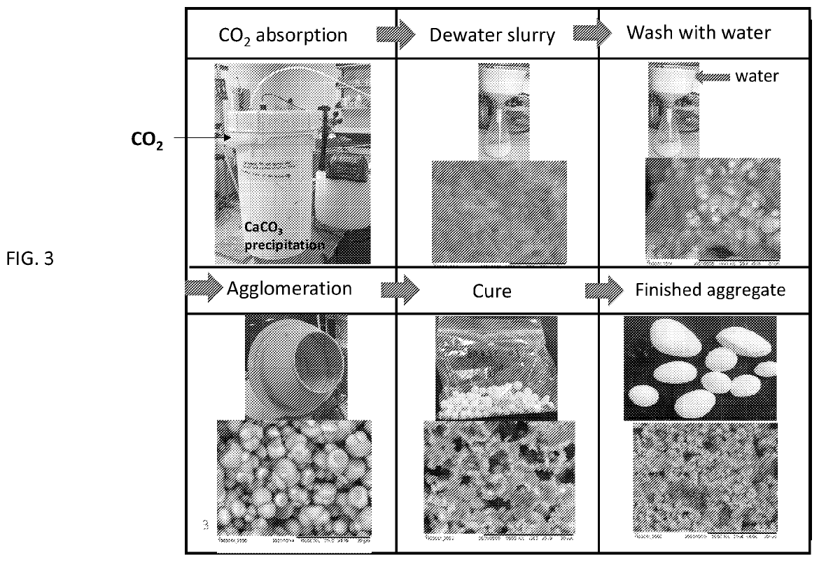

FIG. 3 illustrates a method for generation of aggregates via a CO₂ sequestering process and corresponding products. CO₂ sequestering process 101 results in a carbonate slurry, which is then dewatered (resulting in calcium carbonate solid 110), washed with water, (optionally) washed with a bicarbonate solution, such as NaHCO3, agglomerated, run through a water test, and cured, so as to produce an example end product of aggregates. In some embodiments, the resulting produced building material, e.g., aggregate for concrete, is used to construct a built structure.

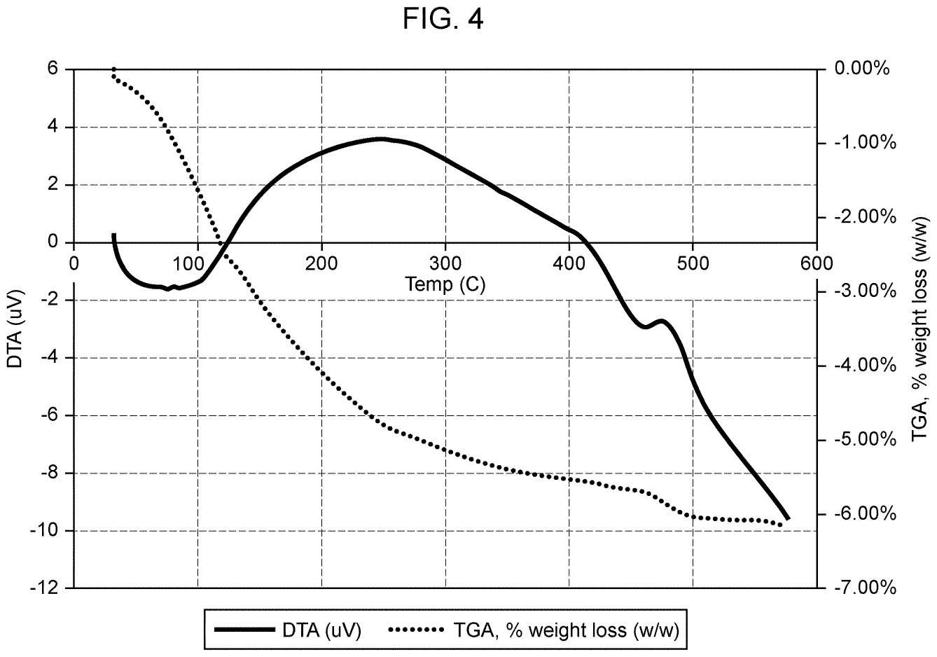

In one embodiment of the method, a pre-aragonite amorphous calcium carbonate (ACC) solid was prepared from solutions of divalent alkaline metal chlorides (primarily calcium chloride) and of ammonium carbonate/bicarbonate with added ammonium sulfate. The two solutions were combined, allowed to precipitate, then filtered and washed with water to remove the salts. The liquid water was then removed from the calcium carbonate before measurement, so that only structural-bound (chemically bound) water was present. Then, the calcium carbonate containing structural-bound water was analyzed using a TGA-DSC instrument, with inert gas flow and a ramp rate of 10 C/min. Results from the TGA-DSC analysis are shown in FIG. 4.

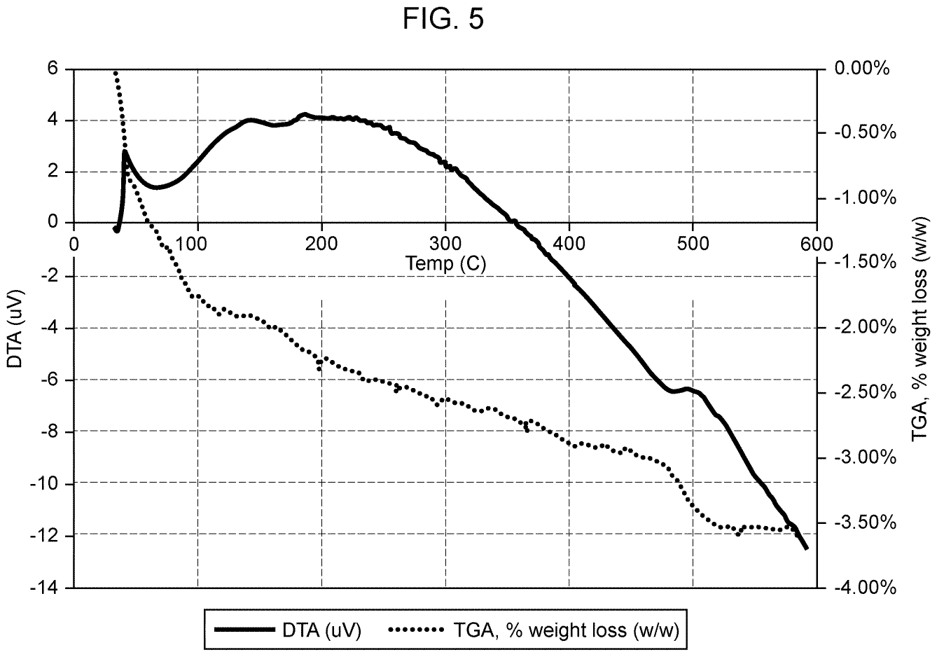

In another embodiment of the method, a pre-vaterite amorphous calcium carbonate (ACC) solid was prepared: an aqueous chemical solution was made using 380 mM CaCl₂, 5 mM MgCl₂, 8 mM (NH₄)₂SO₄, 700 mM NH₄Cl, and 511 mM NH₃. Then, an air-CO₂ mixture that was 6-8 wt % CO₂ was bubbled through the solution to precipitate CaCO₃. The precipitate was separated using filtration and washed with water. The liquid water was then removed from the calcium carbonate before measurement, so that only structural-bound (chemically bound) water was present. Then, the calcium carbonate containing structural-bound water was analyzed using a TGA-DSC instrument, with inert gas flow and a ramp rate of 10 C/min. Results from the TGA-DSC analysis are shown in FIG. 5.

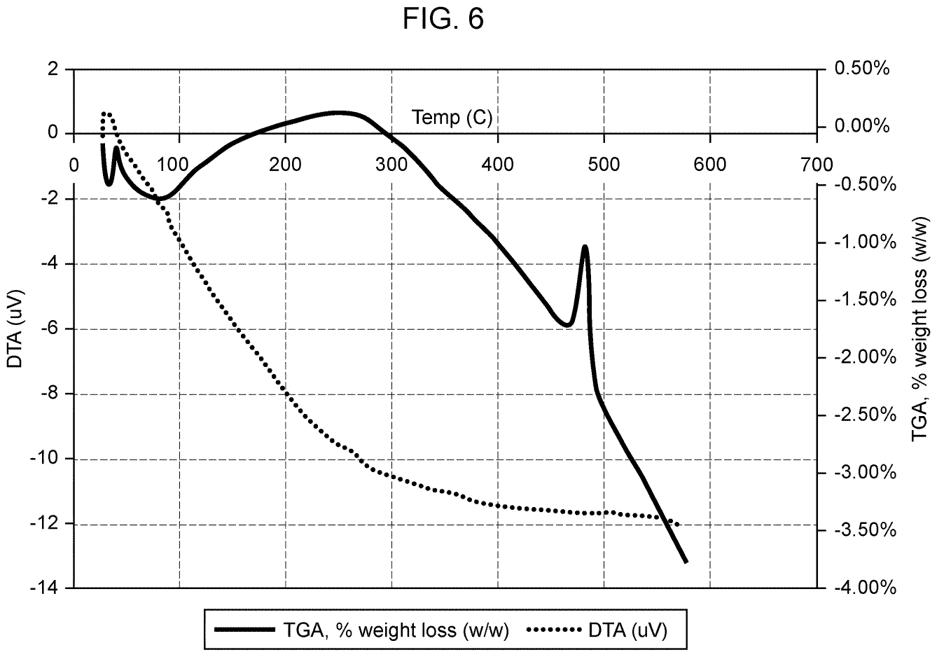

In one embodiment of the method, a pre-calcite amorphous calcium carbonate (ACC) solid was prepared from a solution of alkali and alkaline earth metal chlorides (primarily CaCl₂) mixed with a solution of ammonium carbonate/bicarbonate. After mixing, the calcium carbonate precipitate that formed was allowed to settle before it was filtered and washed with water to remove the salts. The liquid water was then removed from the calcium carbonate before measurement, so that only structural-bound (chemically bound) water was present. Then, the calcium carbonate containing structural-bound water was measured using a TGA-DSC instrument, with inert gas flow and a ramp rate of 10 C/min. Results from the TGA-DSC analysis are shown in FIG. 6.

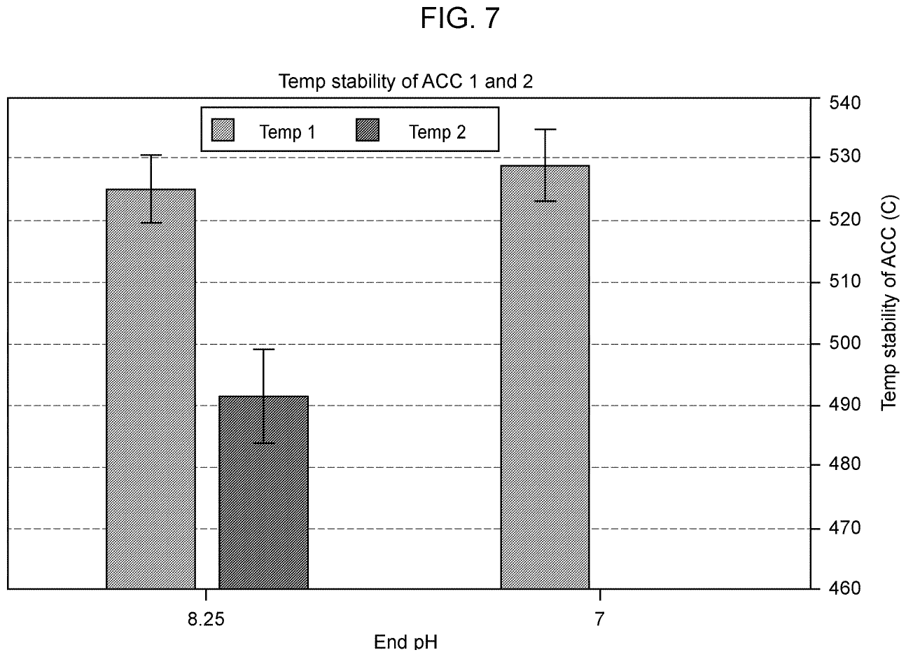

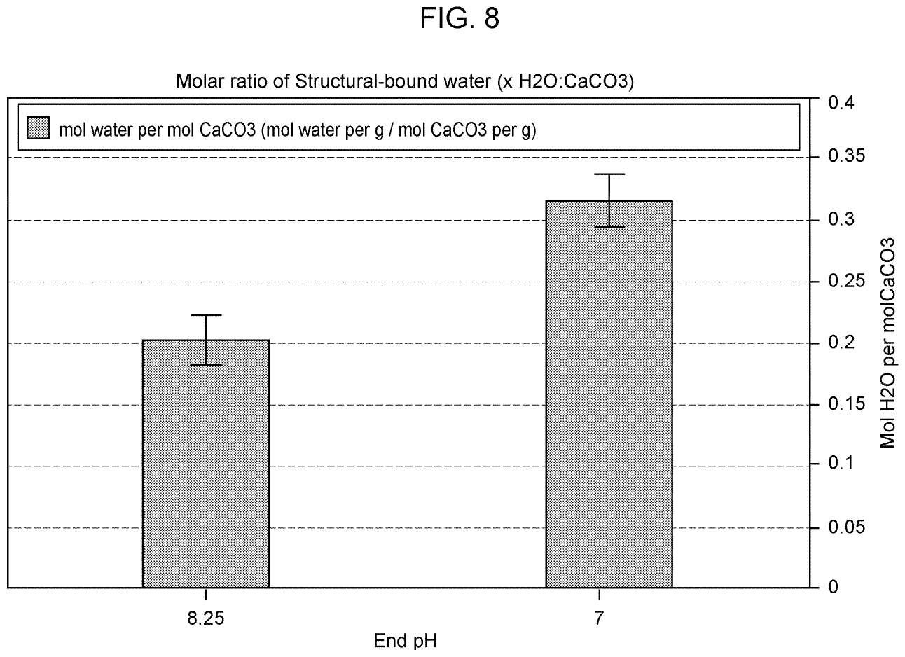

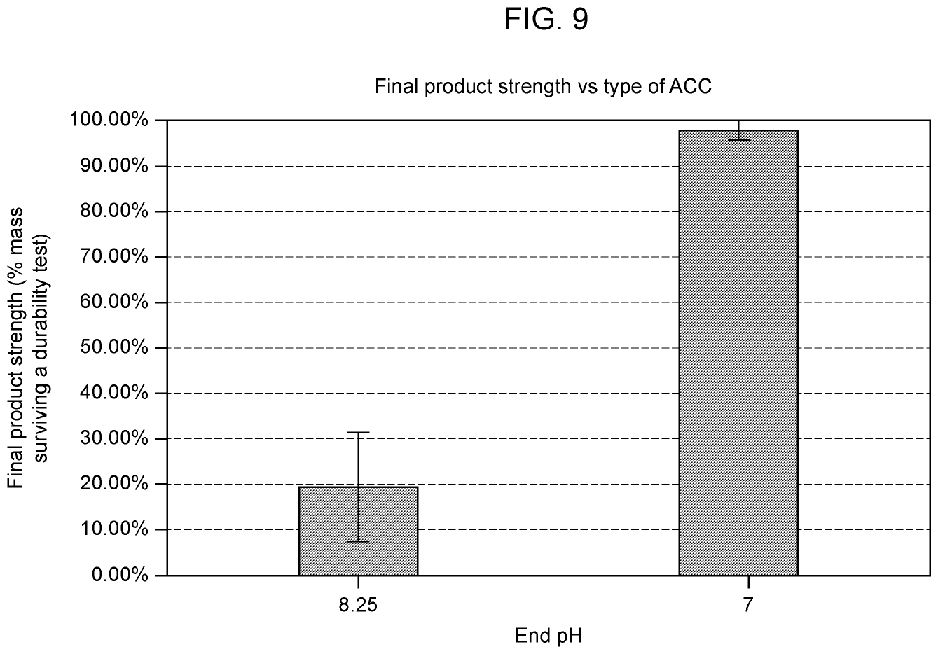

FIGS. 7, 8 and 9 show data from the analyses of an amorphous calcium carbonate (ACC) solid prepared from one embodiment of the method. A solution containing divalent cations, alkalinity, and ammonia—ammonium chloride, was prepared by contacting recycled concrete aggregate with a 1 M ammonium chloride solution in a countercurrent flow, e.g., as described in U.S. patent application Ser. No. 17/261,678 filed on Jan. 20, 2021 and published as US 2021-0262320 A1 (Attorney docket no. BLUE-043); the disclosure of which is herein incorporated by reference. The solution was separated from the solids, and it was contacted with a gaseous mixture of air-CO₂ that was 6-8 wt % CO₂. This resulted in precipitation of CaCO₃ solid, which was sampled at two points during the reaction, one at higher pH (pH 8.25), and one at lower pH (pH 7). Each sample of CaCO₃ precipitate was filtered and washed with water. The liquid (non-structural) water was then removed from the calcium carbonate before measurement, so that only structural-bound (chemically bound) water was present during analyses. Then, the calcium carbonate precipitates containing structural-bound water were measured using a TGA-DSC instrument, with inert gas flow and a ramp rate of 10° C./min, the results of which are shown in FIGS. 7 and 8. After conversion into hardened calcium carbonate aggregate, the calcium carbonate solids were subjected to a durability test (FIG. 9).

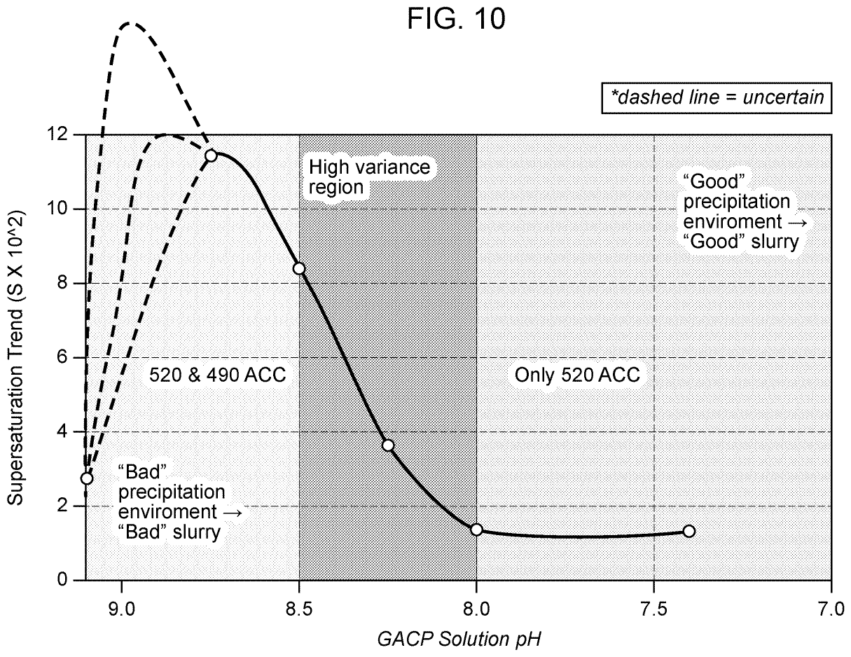

FIG. 10 summarizes a collection of data from another embodiment of the method, for example, from a gas absorption carbonate precipitation (GACP) process for sequestering CO₂ as a calcium carbonate solid. Prior to starting the GACP, a 250 ml vacuum filter flask was thoroughly cleaned so as to not contaminate the filtrate. A 12 L solution comprised of calcium chloride, magnesium chloride, ammonium chloride and aqueous ammonia was mixed thoroughly in a lab-scale GACP reactor. Throughout the GACP process, 5 mL samples of reformate were collected for analyses, e.g., for collecting dissolved inorganic carbon (DIC) data throughout the reaction in order to get an idea of the trends of supersaturation (S) throughout the reaction. The GACP process was briefly stopped at each point pH 8.75, 8.5, 8.25, 8, and 7.4, whereby the gas bubbler was removed from the reactor and the solution was stirred vigorously. 150-200 mL of solution was sampled and filtered through a Büchner funnel equipped with 1.5 um filter paper. Filtrate was analyzed by DIC, ion chromatography, pH and conductivity. Calcium carbonate precipitate collected on the filter paper was analyzed by TGA-DSC, and was then processed into hardened calcium carbonate aggregate. The quality of the aggregate was then determined by a standard durability test.

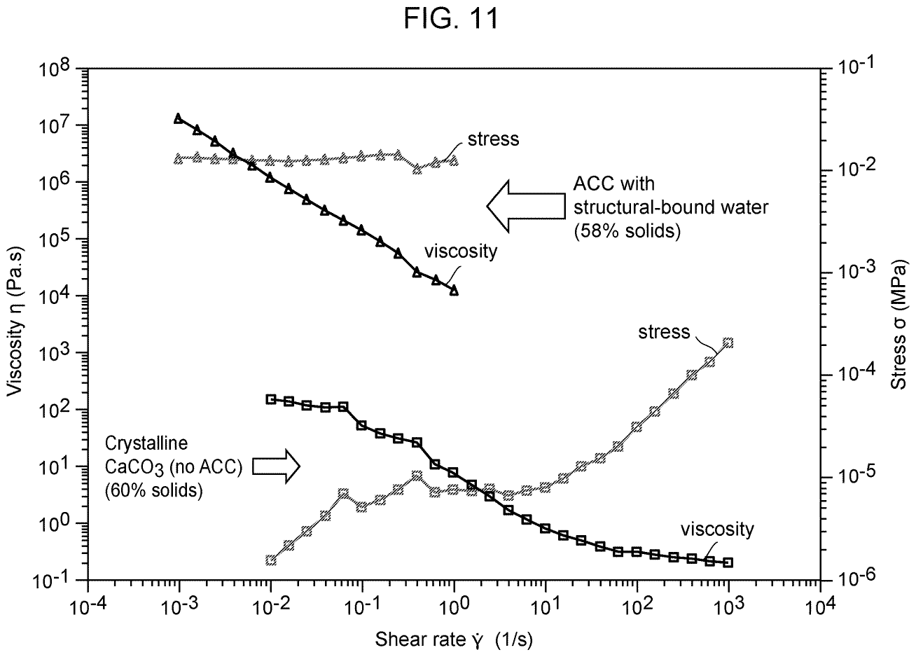

An amorphous calcium carbonate (ACC) solid, was prepared by one embodiment of the method described above for pre-aragonite ACC solid, whereby its Composition 100 (FIG. 1) is 42% liquid water and 58% solids, on a mass basis. Separately, and for comparison, a crystalline CaCO₃ sample that was primarily vaterite (no ACC solid present) having 60% solids and 40% water by mass was also prepared. The samples were loaded onto a rotational rheometer with textured plates, and a rotational shear sweep was run. The comparison of these data is shown in FIG. 11.

### Amorphous Calcium Carbonate (ACC)

As is understood in the art, ACC describes a state of calcium carbonate lacking a crystalline structure. ACC is a generally transient form of calcium carbonate that will transform into a polymorph under certain conditions (e.g., in the presence of water and/or heat). ACC may include different levels of hydration. In some embodiments, ACC is hydrated (i.e., includes one or more structural waters). In certain cases, hydrated ACC can include approximately up to 1.6 mol of structural water per mol of calcium carbonate, for example, between 0.1 mol and 0.4 mol structural water per mol of calcium carbonate, such as between 0.2 mol and 0.3 mol structural water per mol of calcium carbonate. In some cases, such as to make a good quality hardened calcium carbonate aggregate, a hydrated ACC with specific crystallization events may be desired. For example, an ACC having a crystallization event between 510 and 535° C., such as between 515 and 525° C. or at 520° C., may be desired. In other cases, such as to produce a calcium carbonate solid, two types of hydrated ACCs with different crystallization events may be desired. For example, two ACCs present with crystallization events occurring between 475 and 500° C. and between 510 and 535° C., respectively, such as between 485 and 495° C. and between 515 and 525° C., respectively, or at 490 and at 520° C., respectively. With some embodiments of the method, the end pH of the solution absorbing CO₂ gas to produce hydrated ACC solid, may affect the type of hydrated ACC solid that is produced. For example, in some cases where the end pH is between pH 8 and pH 9.5, such as between pH 8.0 and pH 8.5, or between pH 8.75 and pH 9.25, two types of hydrated ACCs may form, for example as described above. In other cases, for example, where the end pH is between pH 7.0 and pH 8.0, such as between pH 7.25 and 7.5, or between pH 7.75 and pH 8.0, a single hydrated ACC having a crystallization event at 520° C. may form, for example as described above. Sometimes, embodiments of the method may be employed so as to control the ratio of structurally bound water to calcium carbonate, for example as described above, while also controlling the end pH and the type of hydrated ACCs, such as to produce quality hardened calcium carbonate aggregate, for example, as described above. In other cases, ACC may be anhydrous.

As discussed herein, a “polymorph” refers to one of a series of crystalline forms that may be derived from an amorphous substance. In other words, polymorphs are compounds that have the same empirical formula but different crystal structures. Polymorphs of interest may include anhydrous polymorphs as well as hydrated polymorphs. For example, anhydrous phases of calcium carbonate include calcite (CaCO₃), aragonite (CaCO₃), and vaterite (CaCO₃). Hydrated phases of calcium carbonate include monohydrocalcite (CaCO₃□H₂O) and ikaite (CaCO₃□6H₂O). Calcite, aragonite, and vaterite are polymorphs of calcium carbonate (CaCO₃) since they all have the same empirical formula of CaCO₃, but they differ from each other in crystal structure, e.g., the crystal structure space groups of calcite, aragonite, and vaterite are R3c, Pmcn, and P6₃/mmc, respectively. ACC and calcium carbonate polymorphs are discussed in, for example, Bots et al. Cryst. Growth Des. (2012) 12:1306-1384; and Radha et al. PNAS. (2010) 107:16438-16443, the disclosures of which are herein incorporated by reference in their entirety.

### Preparation of Composition

As discussed above, methods of the invention include preparing a composition 100 comprising.

In some instances, the composition 100 is produced using a CO₂ sequestering process. By CO₂ sequestering process is meant a process that converts an amount of gaseous CO₂ into a carbonate solution, thereby sequestering CO₂. A variety of difference CO₂ sequestering processes may be employed to produce the carbonate slurry composition.

In some instances, an ammonia mediated CO₂ sequestering process is employed to produce the composition 100. Embodiments of such methods include multistep or single step protocols, as desired. For example, in some embodiments, combination of a CO₂ capture liquid and gaseous source of CO₂ results in production of an aqueous carbonate, which aqueous carbonate is then subsequently contacted with a divalent cation source, e.g., a Ca²⁺ and/or Mg²⁺ source, to produce the polymorph precursor composition. In yet other embodiments, a one-step CO₂ gas absorption carbonate precipitation protocol is employed.

The CO₂ containing gas may be pure CO₂ or be combined with one or more other gases and/or particulate components, depending upon the source, e.g., it may be a multi-component gas (i.e., a multi-component gaseous stream). In certain embodiments, the CO₂ containing gas is obtained from an industrial plant, e.g., where the CO₂ containing gas is a waste feed from an industrial plant. Industrial plants from which the CO₂ containing gas may be obtained, e.g., as a waste feed from the industrial plant, may vary. Industrial plants of interest include, but are not limited to, power plants and industrial product manufacturing plants, such as, but not limited to, chemical and mechanical processing plants, refineries, cement plants, steel plants, etc., as well as other industrial plants that produce CO₂ as a byproduct of fuel combustion or other processing step (such as calcination by a cement plant). Waste feeds of interest include gaseous streams that are produced by an industrial plant, for example as a secondary or incidental product, of a process carried out by the industrial plant.

Of interest in certain embodiments are waste streams produced by industrial plants that combust fossil fuels, e.g., coal, oil, natural gas, as well as man-made fuel products of naturally occurring organic fuel deposits, such as but not limited to tar sands, heavy oil, oil shale, etc. In certain embodiments, power plants are pulverized coal power plants, supercritical coal power plants, mass burn coal power plants, fluidized bed coal power plants, gas or oil-fired boiler and steam turbine power plants, gas or oil-fired boiler simple cycle gas turbine power plants, and gas or oil-fired boiler combined cycle gas turbine power plants. Of interest in certain embodiments are waste streams produced by power plants that combust syngas, i.e., gas that is produced by the gasification of organic matter, e.g., coal, biomass, etc., where in certain embodiments such plants are integrated gasification combined cycle (IGCC) plants. Of interest in certain embodiments are waste streams produced by Heat Recovery Steam Generator (HRSG) plants. Waste streams of interest also include waste streams produced by cement plants. Cement plants whose waste streams may be employed in methods of the invention include both wet process and dry process plants, which plants may employ shaft kilns or rotary kilns, and may include pre-calciners. Each of these types of industrial plants may burn a single fuel, or may burn two or more fuels sequentially or simultaneously. A waste stream of interest is industrial plant exhaust gas, e.g., a flue gas. By “flue gas” is meant a gas that is obtained from the products of combustion from burning a fossil or biomass fuel that are then directed to the smokestack, also known as the flue of an industrial plant. These industrial plants may each burn a single fuel or may burn two or more fuels sequentially or simultaneously. Other industrial plants such as smelters and refineries are also useful sources of waste streams that include carbon dioxide.

Industrial waste gas streams may contain carbon dioxide as the primary non-air derived component, or may, especially in the case of coal-fired power plants, contain additional components (which may be collectively referred to as non-CO₂ pollutants) such as nitrogen oxides (Nox), sulfur oxides (SOx), and one or more additional gases. Additional gases and other components may include CO, mercury and other heavy metals, and dust particles (e.g., from calcining and combustion processes). Additional non-CO₂ pollutant components in the gas stream may also include halides such as hydrogen chloride and hydrogen fluoride; particulate matter such as fly ash, dusts, and metals including arsenic, beryllium, boron, cadmium, chromium, chromium VI, cobalt, lead, manganese, mercury, molybdenum, selenium, strontium, thallium, and vanadium; and organics such as hydrocarbons, dioxins, and PAH compounds. Suitable gaseous waste streams that may be treated have, in some embodiments, CO₂ present in amounts of 200 ppm to 1,000,000 ppm; or 200 ppm to 500,000 ppm; or 200 ppm to 100,000 ppm; or 200 ppm to 10,000; or 200 ppm to 5,000 ppm; or 200 ppm to 2000 ppm; or 200 ppm to 1000 ppm; or 200 to 500 ppm; or 500 ppm to 1,000,000 ppm; or 500 ppm to 500,000 ppm; or 500 ppm to 100,000 ppm; or 500 ppm to 10,000; or 500 ppm to 5,000 ppm; or 500 ppm to 2000 ppm; or 500 ppm to 1000 ppm; or 1000 ppm to 1,000,000 ppm; or 1000 ppm to 500,000 ppm; or 1000 ppm to 100,000 ppm; or 1000 ppm to 10,000; or 1000 ppm to 5,000 ppm; or 1000 ppm to 2000 ppm; or 2000 ppm to 1,000,000 ppm; or 2000 ppm to 500,000 ppm; or 2000 ppm to 100,000 ppm; or 2000 ppm to 10,000; or 2000 ppm to 5,000 ppm; or 2000 ppm to 3000 ppm; or 5000 ppm to 1,000,000 ppm; or 5000 ppm to 500,000 ppm; or 5000 ppm to 100,000 ppm; or 5000 ppm to 10,000; or 10,000 ppm to 1,000,000 ppm; or 10,00 ppm to 500,000 ppm; or 10,000 ppm to 100,000 ppm; or 50,000 ppm to 1,000,000 ppm; or 50,000 ppm to 500,000 ppm; or 50,000 ppm to 100,000 ppm; or 100,000 ppm to 1,000,000 ppm; or 100,000 ppm to 500,000 ppm; or 200,000 ppm to 1000 ppm, including 200,000 ppm to 2000 ppm, for example 180,000 ppm to 2000 ppm, or 180,000 ppm to 5000 ppm, also including 180,000 ppm to 10,000 ppm.

The waste streams, particularly various waste streams of combustion gas, may include one or more additional non-CO₂ components, for example only, water, Nox (mononitrogen oxides: NO and NO₂), SOx (monosulfur oxides: SO, SO₂ and SO₃), VOC (volatile organic compounds), heavy metals such as, but not limited to, mercury, and particulate matter (particles of solid or liquid suspended in a gas). Flue gas temperature may also vary. In some embodiments, the temperature of the flue gas comprising CO₂ is from 0° C. to 2000° C., or 0° C. to 1000° C., or 0° C. to 500° C., or 0° C. to 100° C., or 0° C. to 50° C., or 10° C. to 2000° C., or 10° C. to 1000° C., or 10° C. to 500° C., or 10° C. to 100° C., or 10° C. to 50° C., or 50° C. to 2000° C., or 50° C. to 1000° C., or 50° C. to 500° C., or 50° C. to 100° C., or 100° C. to 2000° C., or 100° C. to 1000° C., or 100° C. to 500° C., or 500° C. to 2000° C., or 500° C. to 1000° C., or 500° C. to 800° C., or such as from 60° C. to 700° C., and including 100° C. to 400° C.

Another gaseous source of CO₂ is a direct air capture (DAC) generated gaseous source of CO₂. The DAC generated gaseous source of CO₂ is a product gas produced by a direct air capture (DAC) system. DAC systems are a class of technologies capable of separating carbon dioxide CO₂ directly from ambient air. A DAC system is any system that captures CO₂ directly from air and generates a product gas that includes CO₂ at a higher concentration than that of the air that is input into the DAC system. While the concentration of CO₂ in the DAC generated gaseous source of CO₂ may vary, in some instances the concentration 1,000 ppm or greater, such as 10,000 ppm or greater, including 100,000 ppm or greater, where the product gas may not be pure CO₂, such that in some instances the product gas is 3% or more non-CO₂ constituents, such as 5% or more non-CO₂ constituents, including 10% or more non-CO₂ constituents. Non-CO₂ constituents that may be present in the product stream may be constituents that originate in the input air and/or from the DAC system. In some instances, the concentration of CO₂ in the DAC product gas ranges from 1,000 to 999,000 ppm, such as 1,000 to 10,000 ppm, or 10,000 to 100,000 ppm or 100,000 to 999,000 ppm. DAC generated gaseous streams have, in some embodiments, CO₂ present in amounts of 200 ppm to 1,000,000 ppm; or 200 ppm to 500,000 ppm; or 200 ppm to 100,000 ppm; or 200 ppm to 10,000; or 200 ppm to 5,000 ppm; or 200 ppm to 2000 ppm; or 200 ppm to 1000 ppm; or 200 to 500 ppm; or 500 ppm to 1,000,000 ppm; or 500 ppm to 500,000 ppm; or 500 ppm to 100,000 ppm; or 500 ppm to 10,000; or 500 ppm to 5,000 ppm; or 500 ppm to 2000 ppm; or 500 ppm to 1000 ppm; or 1000 ppm to 1,000,000 ppm; or 1000 ppm to 500,000 ppm; or 1000 ppm to 100,000 ppm; or 1000 ppm to 10,000; or 1000 ppm to 5,000 ppm; or 1000 ppm to 2000 ppm; or 2000 ppm to 1,000,000 ppm; or 2000 ppm to 500,000 ppm; or 2000 ppm to 100,000 ppm; or 2000 ppm to 10,000; or 2000 ppm to 5,000 ppm; or 2000 ppm to 3000 ppm; or 5000 ppm to 1,000,000 ppm; or 5000 ppm to 500,000 ppm; or 5000 ppm to 100,000 ppm; or 5000 ppm to 10,000; or 10,000 ppm to 1,000,000 ppm; or 10,00 ppm to 500,000 ppm; or 10,000 ppm to 100,000 ppm; or 50,000 ppm to 1,000,000 ppm; or 50,000 ppm to 500,000 ppm; or 50,000 ppm to 100,000 ppm; or 100,000 ppm to 1,000,000 ppm; or 100,000 ppm to 500,000 ppm; or 200,000 ppm to 1000 ppm, including 200,000 ppm to 2000 ppm, for example 180,000 ppm to 2000 ppm, or 180,000 ppm to 5000 ppm, also including 180,000 ppm to 10,000 ppm.

The DAC product gas that is contacted with the aqueous capture liquid may be produced by any convenient DAC system. DAC systems are systems that extract CO₂ from the air using media that binds to CO₂ but not to other atmospheric chemicals (such as nitrogen and oxygen). As air passes over the CO₂ binding medium, CO₂ “sticks” to the binding medium. In response to a stimulus, e.g., heat, humidity, etc., the bound CO₂ may then be released from the binding medium resulting the production of a gaseous CO₂ containing product. DAC systems of interest include, but are not limited to: hydroxide-based systems; CO₂ sorbent/temperature swing-based systems, and CO₂ sorbent/temperature swing-based systems. In some instances, the DAC system is a hydroxide-based system, in which CO₂ is separated from air by contacting the air with is an aqueous hydroxide liquid. Examples of hydroxide-based DAC systems include, but are not limited to, those described in PCT published application Nos. WO/2009/155539; WO/2010/022339; WO/2013/036859; and WO/2013/120024; the disclosures of which are herein incorporated by reference. In some instances, the DAC system is a CO₂ sorbent-based system, in which CO₂ is separated from air by contacting the air with sorbent, such as an amine sorbent, followed by release of the sorbent captured CO₂ by subjecting the sorbent to one or more stimuli, e.g., change in temperature, change in humidity, etc. Examples of such DAC systems include, but are not limited to, those described in PCT published application Nos. WO/2005/108297; WO/2006/009600; WO/2006/023743; WO/2006/036396; WO/2006/084008; WO/2007/016271; WO/2007/114991; WO/2008/042919; WO/2008/061210; WO/2008/131132; WO/2008/144708; WO/2009/061836; WO/2009/067625; WO/2009/105566; WO/2009/149292; WO/2010/019600; WO/2010/022399 ; WO/2010/107942; WO/2011/011740; WO/2011/137398; WO/2012/106703; WO/2013/028688; WO/2013/075981; WO/2013/166432; WO/2014/170184; WO/2015/103401; WO/2015/185434; WO/2016/005226; WO/2016/037668; WO/2016/162022; WO/2016/164563; WO/2016/161998; WO/2017/184652; and WO/2017/009241; the disclosures of which are herein incorporated by reference.

As summarized above, an aqueous capture liquid is contacted with the gaseous source of CO₂ under conditions sufficient to produce an aqueous carbonate. The aqueous capture liquid may vary. Examples of aqueous capture liquids include, but are not limited to fresh water to bicarbonate buffered aqueous media. Bicarbonate buffered aqueous media employed in embodiments of the invention include liquid media in which a bicarbonate buffer is present. The bicarbonate buffered aqueous medium may be a naturally occurring or man-made medium, as desired. Naturally occurring bicarbonate buffered aqueous media include, but are not limited to, waters obtained from seas, oceans, lakes, swamps, estuaries, lagoons, brines, alkaline lakes, inland seas, etc. Man-made sources of bicarbonate buffered aqueous media may also vary, and may include brines produced by water desalination plants, and the like. Further details regarding such capture liquids are provided in PCT published application Nos. WO2014/039578; WO 2015/134408; and WO 2016/057709; the disclosures of which applications are herein incorporated by reference.

In some embodiments, an aqueous capture ammonia is contacted with the gaseous source of CO₂ under conditions sufficient to produce an aqueous ammonium carbonate. The concentration of ammonia in the aqueous capture ammonia may vary, where in some instances the aqueous capture ammonia includes ammonia (NH₃) at a concentration ranging from 10 ppm to 350,000 ppm NH₃, such as 10 to 10,000 ppm, or 10 to 1,000 ppm, or 10 to 5,000 ppm, or 10 to 8,000 ppm, or 10 to 10,000 ppm, or 100 to 100,000 ppm, or 100 to 10,000 ppm, or 100 to 50,000 ppm, or 100 to 80,000 ppm, or 100 to 100,000 ppm, or 1,000 to 350,000 ppm, or 1,000 to 50,000 ppm, or 1,000 to 80,000 ppm, or 1,000 to 100,000 ppm, or 1,000 to 200,000 ppm, or 1,000 to 350,000 ppm, or such as from 6,000 to 85,000 ppm, and including 8,000 to 50,000 ppm. The aqueous capture ammonia may include any convenient water. Waters of interest from which the aqueous capture ammonia may be produced include, but are not limited to, freshwaters, seawaters, brine waters, reclaimed or recycled waters, produced waters and waste waters. The pH of the aqueous capture ammonia may vary, ranging in some instances from 9.0 to 13.5, such as 9.0 to 13.0, including 10.5 to 12.5. Further details regarding aqueous capture ammonias of interest are provided in PCT published application No. WO 2017/165849; the disclosure of which is herein incorporated by reference.

The CO₂ containing gas, e.g., as described above, may be contacted with the aqueous capture liquid, e.g., aqueous capture ammonia, using any convenient protocol. For example, contact protocols of interest include, but are not limited to: direct contacting protocols, e.g., bubbling the gas through a volume of the aqueous medium, concurrent contacting protocols, i.e., contact between unidirectionally flowing gaseous and liquid phase streams, countercurrent protocols, i.e., contact between oppositely flowing gaseous and liquid phase streams, and the like. Contact may be accomplished through use of infusers, bubblers, fluidic Venturi reactors, spargers, gas filters, sprays, trays, scrubbers, absorbers or packed column reactors, and the like, as may be convenient. In some instances, the contacting protocol may use a conventional absorber or an absorber froth column, such as those described in U.S. Pat. Nos. 7,854,791; 6,872,240; and 6,616,733; and in United States Patent Application Publication US-2012-0237420-A1; the disclosures of which are herein incorporated by reference. The process may be a batch or continuous process. In some instances, a regenerative froth contactor (RFC) may be employed to contact the CO₂ containing gas with the aqueous capture liquid, e.g., aqueous capture ammonia. In some such instances, the RFC may use a catalyst (such as described elsewhere), e.g., a catalyst that is immobilized on/to the internals of the RFC. Further details regarding a suitable RFC are found in U.S. Pat. No. 9,545,598, the disclosure of which is herein incorporated by reference.

In some instances, the gaseous source of CO₂ is contacted with the liquid using a microporous membrane contactor. Microporous membrane contactors of interest include a microporous membrane present in a suitable housing, where the housing includes a gas inlet and a liquid inlet, as well a gas outlet and a liquid outlet. The contactor is configured so that the gas and liquid contact opposite sides of the membrane in a manner such that molecule may dissolve into the liquid from the gas via the pores of the microporous membrane. The membrane may be configured in any convenient format, where in some instances the membrane is configured in a hollow fiber format. Hollow fiber membrane reactor formats which may be employed include, but are not limited to, those described in U.S. Pat. Nos. 7,264,725; 6,872,240 and 5,695,545; the disclosures of which are herein incorporated by reference. In some instances, the microporous hollow fiber membrane contactor that is employed is a hollow fiber membrane contactor, which membrane contactors include polypropylene membrane contactors and polyolefin membrane contactors.

Contact between the capture liquid and the CO₂-containing gas occurs under conditions such that a substantial portion of the CO₂ present in the CO₂-containing gas goes into solution, e.g., to produce bicarbonate ions. By substantial portion is meant 10 % or more, such as 50% or more, including 80% or more.

The temperature of the capture liquid that is contacted with the CO₂-containing gas may vary. In some instances, the temperature ranges from −1.4 to 100° C., such as 20 to 80° C. and including 40 to 70° C. In some instances, the temperature may range from −1.4 to 50° C. or higher, such as from −1.1 to 45° C. or higher. In some instances, cooler temperatures are employed, where such temperatures may range from −1.4 to 4° C., such as −1.1 to 0° C. In some instances, warmer temperatures are employed. For example, the temperature of the capture liquid in some instances may be 25° C. or higher, such as 30° C. or higher, and may in some embodiments range from 25 to 50° C., such as 30 to 40° C.

The CO₂-containing gas and the capture liquid are contacted at a pressure suitable for production of a desired CO₂ charged liquid. In some instances, the pressure of the contact conditions is selected to provide for optimal CO₂ absorption, where such pressures may range from 1 ATM to 100 ATM, such as 1 to 50 ATM, e.g., 20-30 ATM or 1 ATM to 10 ATM. Where contact occurs at a location that is naturally at 1 ATM, the pressure may be increased to the desired pressure using any convenient protocol. In some instances, contact occurs where the optimal pressure is present, e.g., at a location under the surface of a body of water, such as an ocean or sea.

In those embodiments where the gaseous source of CO₂ is contacted with an aqueous capture ammonia, contact is carried out in a manner sufficient to produce an aqueous ammonium carbonate. The aqueous ammonium carbonate may vary, where in some instances the aqueous ammonium carbonate comprises at least one of ammonium carbonate and ammonium bicarbonate and in some instances comprises both ammonium carbonate and ammonium bicarbonate. The aqueous ammonium bicarbonate may be viewed as a DIC containing liquid. As such, in charging the aqueous capture ammonia with CO₂, a CO₂ containing gas may be contacted with CO₂ capture liquid under conditions sufficient to produce dissolved inorganic carbon (DIC) in the CO₂ capture liquid, i.e., to produce a DIC containing liquid. The DIC is the sum of the concentrations of inorganic carbon species in a solution, represented by the equation: DIC=[CO₂*]+[HCO₃⁻]+[CO₃²⁻], where [CO₂*] is the sum of carbon dioxide ([CO₂]) and carbonic acid ([H₂CO₃]) concentrations, [HCO₃] is the bicarbonate concentration (which includes ammonium bicarbonate) and [CO₃²⁻] is the carbonate concentration (which includes ammonium carbonate) in the solution. The DIC of the aqueous media may vary, and in some instances may be 3 ppm to 168,000 ppm carbon I, such as 3 to 1,000 ppm, or 3 to 100 ppm, or 3 to 500 ppm, or 3 to 800 ppm, or 3 to 1,000 ppm, or 100 to 10,000 ppm, or 100 to 1,000 ppm, or 100 to 5,000 ppm, or 100 to 8,000 ppm, or 100 to 10,000 ppm, or 1,000 to 50,000 ppm, or 1,000 to 8,000 ppm, or 1,000 to 15,000 ppm, or 1,000 to 30,000 ppm, or 5,000 to 168,000 ppm, or 5,000 to 25,000 ppm, or such as from 6,000 to 65,000 ppm, and including 8,000 to 95,000 ppm carbl(C). The amount of CO₂ dissolved in the liquid may vary, and in some instances ranges from 0.05 to 40 mM, such as 1 to 35 mM, including 25 to 30 mM. The pH of the resultant DIC containing liquid may vary, ranging in some instances from 4 to 12, such as 6 to 11 and including 7 to 11, e.g., 8 to 9.5.

Where desired, the CO₂ containing gas is contacted with the capture liquid in the presence of a catalyst (i.e., an absorption catalyst, either hetero-or homogeneous in nature) that mediates the conversion of CO₂ to bicarbonate. Of interest as absorption catalysts are catalysts that, at pH levels ranging from 8 to 10, increase the rate of production of bicarbonate ions from dissolved CO₂. The magnitude of the rate increase (e.g., as compared to control in which the catalyst is not present) may vary, and in some instances is 2-fold or greater, such as 5-fold or greater, e.g., 10-fold or greater, as compared to a suitable control. Further details regarding examples of suitable catalysts for such embodiments are found in U.S. Pat. No. 9,707,513, the disclosure of which is herein incorporated by reference.

In some embodiments, the resultant aqueous carbonate is a two-phase liquid which includes droplets of a liquid condensed phase (LCP) in a bulk liquid, e.g., bulk solution. By “liquid condensed phase” or “LCP” is meant a phase of a liquid solution which includes bicarbonate ions wherein the concentration of bicarbonate ions is higher in the LCP phase than in the surrounding, bulk liquid. LCP droplets are characterized by the presence of a meta-stable bicarbonate-rich liquid precursor phase in which bicarbonate ions associate into condensed concentrations exceeding that of the bulk solution and are present in a non-crystalline solution state. The LCP contains all of the components found in the bulk solution that is outside of the interface. However, the concentration of the bicarbonate ions is higher than in the bulk solution. In those situations where LCP droplets are present, the LCP and bulk solution may each contain ion-pairs and pre-nucleation clusters (PNCs). When present, the ions remain in their respective phases for long periods of time, as compared to ion-pairs and PNCs in solution. Further details regarding LCP containing liquids are provided in U.S. patent application Ser. No. 14/636,043, the disclosure of which is herein incorporated by reference.

Accordingly, in some embodiments, following production of an aqueous carbonate, such as an aqueous ammonium carbonate, e.g., as described above, the aqueous carbonate is subsequently combined with a cation source under conditions sufficient to produce a solid CO₂ sequestering carbonate. Cations of different valances can form solid carbonate compositions (e.g., in the form of carbonate minerals). In some instances, monovalent cations, such as sodium and potassium cations, may be employed. In other instances, divalent cations, such as alkaline earth metal cations, e.g., calcium (Ca²⁺) and magnesium (Mg²⁺) cations, may be employed. When cations are added to the aqueous carbonate, precipitation of carbonate solids, such as amorphous calcium carbonate (CaCO₃) when the divalent cations include Ca²⁺, may be produced with a stoichiometric ratio of one carbonate-species ion per cation.

Any convenient cation source may be employed in such instances. Cation sources of interest include, but are not limited to, the brine from water processing facilities such as sea water desalination plants, brackish water desalination plants, groundwater recovery facilities, wastewater facilities, blowdown water from facilities with cooling towers, and the like, which produce a concentrated stream of solution high in cation contents. Also of interest as cation sources are naturally occurring sources, such as but not limited to native seawater and geological brines, which may have varying cation concentrations and may also provide a ready source of cations to trigger the production of carbonate solids from the aqueous ammonium carbonate. In some instances, the cation source may be a waste product of another step of the process, e.g., a calcium salt (such as CaCl₂) produced during regeneration of ammonia from the aqueous ammonium salt.

In yet other embodiments, the aqueous capture ammonia includes cations, e.g., as described above. The cations may be provided in the aqueous capture ammonia using any convenient protocol. In some instances, the cations present in the aqueous capture ammonia are derived from a geomass (e.g., recycled concrete aggregate (RCA)) used in regeneration of the aqueous capture ammonia from an aqueous ammonium salt. In addition, and/or alternatively, the cations may be provided by combining an aqueous capture ammonia with a cation source, e.g., as described above.

Following production of an aqueous carbonate, such as an aqueous ammonium carbonate, e.g., as described above, the aqueous carbonate is combined with a cation source under conditions sufficient to produce a solid CO₂ sequestering carbonate. Cations of different valances can form solid carbonate compositions (e.g., in the form of carbonate minerals). In some instances, monovalent cations, such as sodium and potassium cations, may be employed. In other instances, divalent cations, such as alkaline earth metal cations, e.g., calcium and magnesium cations, may be employed. Transition metals may also be employed, e.g., Fe, Mn, Cu, etc. When cations are added to the aqueous carbonate, precipitation of carbonate solids, such as amorphous calcium carbonate when the divalent cations include Ca²⁺, may be produced with a stoichiometric ratio of one carbonate-species ion per cation.

As summarized above, production of CO₂ sequestering carbonate from the aqueous ammonia capture liquid and the gaseous source of CO₂ yields an aqueous ammonium salt. The produced aqueous ammonium salt may vary with respect to the nature of the anion of the ammonium salt, where specific ammonium salts that may be present in the aqueous ammonium salt include, but are not limited to, ammonium chloride, ammonium acetate, ammonium sulfate, ammonium nitrate, etc.

Some aspects of the invention further include regenerating an aqueous capture ammonia, e.g., as described above, from the aqueous ammonium salt. By regenerating an aqueous capture ammonium is meant processing the aqueous ammonium salt in a manner sufficient to generate an amount of ammonium from the aqueous ammonium salt. The percentage of input ammonium salt that is converted to ammonia during this regeneration step may vary, ranging in some instances from 5 to 80%, such as 15 to 55%, and in some instances 20 to 80%, e.g., 35 to 55%.

Ammonia may be regenerated from an aqueous ammonium salt in this regeneration step using any convenient regeneration protocol. In some instances, a distillation protocol is employed. While any convenient distillation protocol may be employed, in some embodiments the employed distillation protocol includes heating the aqueous ammonium salt in the presence of an alkalinity source, e.g., geomass, to produce a gaseous ammonia/water product, which may then be condensed to produce a liquid aqueous capture ammonia. In some instances, the protocol happens continuously in a stepwise process wherein heating the aqueous ammonium salt in the present of an alkalinity source happens before the distillation and condensation of liquid aqueous capture ammonia.

The alkalinity source may vary, so long as it is sufficient to convert ammonium in the aqueous ammonium salt to ammonia. Any convenient alkalinity source may be employed. Alkalinity sources that may be employed in this regeneration step include chemical agents. Chemical agents that may be employed as alkalinity sources include, but are not limited to, hydroxides, organic bases, super bases, oxides, and carbonates. Hydroxides include chemical species that provide hydroxide anions in solution, including, for example, sodium hydroxide (NaOH), potassium hydroxide (KOH), calcium hydroxide (Ca(OH)₂), or magnesium hydroxide (Mg(OH)₂). Organic bases are carbon-containing molecules that are generally nitrogenous bases including primary amines such as methyl amine, secondary amines such as diisopropylamine, tertiary such as diisopropylethylamine, aromatic amines such as aniline, heteroaromatics such as pyridine, imidazole, and benzimidazole, and various forms thereof. Super bases suitable for use as proton-removing agents include sodium ethoxide, sodium amide (NaNH₂), sodium hydride (NaH), butyl lithium, lithium diisopropylamide, lithium diethylamide, and lithium bis(trimethylsilyl)amide. Oxides including, for example, calcium oxide (CaO), magnesium oxide (MgO), strontium oxide (SrO), beryllium oxide (BeO), and barium oxide (BaO) are also suitable proton-removing agents that may be used.

Also of interest as alkalinity sources are silica sources. The source of silica may be pure silica or a composition that includes silica in combination with other compounds, e.g., minerals, so long as the source of silica is sufficient to impart desired alkalinity. In some instances, the source of silica is a naturally occurring source of silica. Naturally occurring sources of silica include silica containing rocks, which may be in the form of sands or larger rocks. Where the source is larger rocks, in some instances the rocks have been broken down to reduce their size and increase their surface area. Of interest are silica sources made up of components having a longest dimension ranging from 0.01 mm to 1 meter, such as 0.1 mm to 500 cm, including 1 mm to 100 cm, e.g., 1 mm to 50 cm. The silica sources may be surface treated, where desired, to increase the surface area of the sources. A variety of different naturally occurring silica sources may be employed. Naturally occurring silica sources of interest include, but are not limited to, igneous rocks, which rocks include: ultramafic rocks, such as Komatiite, Picrite basalt, Kimberlite, Lamproite, Peridotite; mafic rocks, such as Basalt, Diabase (Dolerite) and Gabbro; intermediate rocks, such as Andesite and Diorite; intermediate felsic rocks, such as Dacite and Granodiorite; and Felsic rocks, such as Rhyolite, Aplite-Pegmatite and Granite. Also of interest are man-made sources of silica. Man-made sources of silica include, but are not limited to, waste streams such as: mining wastes; fossil fuel burning ash; slag, e.g. iron and steel slags, phosphorous slag; cement kiln waste; oil refinery/petrochemical refinery waste, e.g. oil field and methane seam brines; coal seam wastes, e.g. gas production brines and coal seam brine; paper processing waste; water softening, e.g. ion exchange waste brine; silicon processing wastes; agricultural waste; metal finishing waste; high pH textile waste; and caustic sludge. Mining wastes include any wastes from the extraction of metal or another precious or useful mineral from the earth. Wastes of interest include wastes from mining to be used to raise pH, including: red mud from the Bayer aluminum extraction process; the waste from magnesium extraction for sea water, e.g., at Moss Landing, Calif.; and the wastes from other mining processes involving leaching. Ash from processes burning fossil fuels, such as coal fired power plants, create ash that is often rich in silica. In some embodiments, ashes resulting from burning fossil fuels, e.g., coal fired power plants, are provided as silica sources, including fly ash, e.g., ash that exits out the smokestack, and bottom ash. Additional details regarding silica sources and their use are described in U.S. Pat. No. 9,714,406; the disclosure of which is herein incorporated by reference.

In embodiments of the invention, ash is employed as an alkalinity source. Of interest in certain embodiments is use of a coal ash as the ash. The coal ash as employed in this invention refers to the residue produced in power plant boilers or coal burning furnaces, for example, chain grate boilers, cyclone boilers and fluidized bed boilers, from burning pulverized anthracite, lignite, bituminous or sub-bituminous coal. Such coal ash includes fly ash which is the finely divided coal ash carried from the furnace by exhaust or flue gases; and bottom ash which collects at the base of the furnace as agglomerates.

Fly ashes are generally highly heterogeneous, and include a mixture of glassy particles with various identifiable crystalline phases such as quartz, mullite, and various iron oxides. Fly ashes of interest include Type F and Type C fly ash. The Type F and Type C fly ashes referred to above are defined by CSA Standard A23.5 and ASTM C618 as mentioned above. The chief difference between these classes is the amount of calcium, silica, alumina, and iron content in the ash. The chemical properties of the fly ash are largely influenced by the chemical content of the coal burned (i.e., anthracite, bituminous, and lignite). Fly ashes of interest include substantial amounts of silica (silicon dioxide, SiO₂) (both amorphous and crystalline) and lime (calcium oxide, CaO, magnesium oxide, MgO).

The burning of harder, older anthracite and bituminous coal typically produces Class F fly ash. Class F fly ash is pozzolanic in nature, and contains less than 10% lime (CaO). Fly ash produced from the burning of younger lignite or subbituminous coal, in addition to having pozzolanic properties, also has some self-cementing properties. In the presence of water, Class C fly ash will harden and gain strength over time. Class C fly ash generally contains more than 20% lime (CaO). Alkali and sulfate (SO₄²⁻) contents are generally higher in Class C fly ashes. In some embodiments it is of interest to use Class C fly ash to regenerate ammonia from an aqueous ammonium salt, e.g., as mentioned above, with the intention of extracting quantities of constituents present in Class C fly ash so as to generate a fly ash closer in characteristics to Class F fly ash, e.g., extracting 95% of the CaO in Class C fly ash that has 20% CaO, thus resulting in a remediated fly ash material that has 1% CaO.

Fly ash material solidifies while suspended in exhaust gases and is collected using various approaches, e.g., by electrostatic precipitators or filter bags. Since the particles solidify while suspended in the exhaust gases, fly ash particles are generally spherical in shape and range in size from 0.5 μm to 100 μm. Fly ashes of interest include those in which at least about 80%, by weight comprises particles of less than 45 microns. Also of interest in certain embodiments of the invention is the use of highly alkaline fluidized bed combustor (FBC) fly ash.

Also of interest in embodiments of the invention is the use of bottom ash. Bottom ash is formed as agglomerates in coal combustion boilers from the combustion of coal. Such combustion boilers may be wet bottom boilers or dry bottom boilers. When produced in a wet or dry bottom boiler, the bottom ash is quenched in water. The quenching results in agglomerates having a size in which 90% fall within the particle size range of 0.1 mm to 20 mm, where the bottom ash agglomerates have a wide distribution of agglomerate size within this range. The main chemical components of a bottom ash are silica and alumina with lesser amounts of oxides of Fe, Ca, Mg, Mn, Na and K, as well as sulfur and carbon.

Also of interest in certain embodiments is the use of volcanic ash as the ash. Volcanic ash is made up of small tephra, i.e., bits of pulverized rock and glass created by volcanic eruptions, less than 2 millimeters in diameter.

In one embodiment of the invention, cement kiln dust (CKD) is employed as an alkalinity source. The nature of the fuel from which the ash and/or CKD were produced, and the means of combustion of said fuel, will influence the chemical composition of the resultant ash and/or CKD. Thus, ash and/or CKD may be used as a portion of the means for adjusting pH, or the sole means, and a variety of other components may be utilized with specific ashes and/or CKDs, based on chemical composition of the ash and/or CKD.

In certain embodiments of the invention, slag is employed as an alkalinity source. The slag may be used as a sole pH modifier or in conjunction with one or more additional pH modifiers, e.g., ashes, etc. Slag is generated from the processing of metals, and may contain calcium and magnesium oxides as well as iron, silicon and aluminum compounds. In certain embodiments, the use of slag as a pH modifying material provides additional benefits via the introduction of reactive silicon and alumina to the precipitated product. Slags of interest include, but are not limited to, blast furnace slag from iron smelting, slag from electric-arc or blast furnace processing of iron and/or steel, copper slag, nickel slag and phosphorus slag.

As indicated above, ash (or slag in certain embodiments) is employed in certain embodiments as the sole way to modify the pH of the water to the desired level. In yet other embodiments, one or more additional pH modifying protocols is employed in conjunction with the use of ash.

Also of interest in certain embodiments is the use of other waste materials, e.g., crushed or demolished or recycled or returned concretes or mortars, as an alkalinity source. When employed, the concrete dissolves releasing sand and aggregate which, where desired, may be recycled to the carbonate production portion of the process. Use of demolished and/or recycled concretes or mortars is further described below.

Of interest in certain embodiments are mineral alkalinity sources. The mineral alkalinity source that is contacted with the aqueous ammonium salt in such instances may vary, where mineral alkalinity sources of interest include, but are not limited to: silicates, carbonates, fly ashes, slags, limes, cement kiln dusts, etc., e.g., as described above. In some instances, the mineral alkalinity source comprises a rock, e.g., as described above.

While the temperature to which the aqueous ammonium salt is heated in these embodiments may vary, in some instances the temperature ranges from 15 to 200° C., such as 25 to 185° C. The heat employed to provide the desired temperature may be obtained from any convenient source, including steam, a waste heat source, such as flue gas waste heat, etc.

Distillation may be carried out at any pressure. Where distillation is carried out at atmospheric pressure, the temperature at which distillation is carried out may vary, ranging in some instances from 50 to 120° C., such as 60 to 100° C., e.g., from 70 to 90° C. In some instances, distillation is carried out at a sub-atmospheric pressure. While the pressure in such embodiments may vary, in some instances the sub-atmospheric pressure ranges from 1 to 14 psig, such as from 2 to 6 psig. Where distillation is carried out at sub-atmospheric pressure, the distillation may be carried out at a reduced temperature as compared to embodiments that are performed at atmospheric pressure. While the temperature may vary in such instances as desired, in some embodiments where a sub-atmospheric pressure is employed, the temperature ranges from 15 to 60° C., such as 25 to 50° C. Of interest in sub-atmospheric pressure embodiments is the use of a waste heat for some, if not all, of the heat employed during distillation. Waste heat sources of that may be employed in such instances include, but are not limited to: flue gas, process steam condensate, heat of absorption generated by CO₂ capture and resultant ammonium carbonate production; and a cooling liquid (such as from a co-located located source of CO₂ containing gas, such as a power plant, factory etc., e.g., as described above), and combinations thereof.

Aqueous capture ammonia regeneration may also be achieved using an electrolysis mediated protocol, in which a direct electric current is introduced into the aqueous ammonium salt to regenerate ammonia. Any convenient electrolysis protocol may be employed. Examples of electrolysis protocols that may be adapted for regeneration of ammonia from an aqueous ammonium salt may employed one or more elements from the electrolysis systems described in U.S. Pat. Nos. 7,727,374 and 8,227,127, as well as published PCT Application Publication No. WO/2008/018928; the disclosures of which are hereby incorporated by reference.

In some instances, the aqueous capture ammonia is regenerated from the aqueous ammonium salt without the input of energy, e.g., in the form of heat and/or electric current, such as described above. In such instances, the aqueous ammonium salt is combined with an alkaline source in a manner sufficient to produce a regenerated aqueous capture ammonia. The resultant aqueous capture ammonia is then not purified, e.g., by input of energy, such as via stripping protocol, etc.

The resultant regenerated aqueous capture ammonia may vary, e.g., depending on the particular regeneration protocol that is employed. In some instances, the regenerated aqueous capture ammonia includes ammonia (NH₃) at a concentration ranging from 0.05 to 25 moles per liter (M), such as from 4 to 20 M, including from 12.0 to 16.0 M, as well as any of the ranges provided for the aqueous capture ammonia provided above. The pH of the aqueous capture ammonia may vary, ranging in some instances from 10.0 to 13.0, such as 10.0 to 12.5. In some instances, e.g., where the aqueous capture ammonia is regenerated in a geomass mediated protocol that does not include input of energy, e.g., as described above, the regenerated aqueous capture ammonia may further include cations, e.g., divalent cations, such as Ca²⁺. In addition, the regenerated aqueous capture ammonia may further include an amount of ammonium salt. In some instances, ammonia (NH₃) is present at a concentration ranging from 0.05 to 4 moles per liter (M), such as from 0.05 to 1 M, including from 0.1 to 2 M. The pH of the aqueous capture ammonia may vary, ranging in some instances from 8.0 to 11.0, such as from 8.0 to 10.0. The aqueous capture ammonia may further include ions, e.g., monovalent cations, such as ammonium (NH₄⁺) at a concentration ranging from 0.1 to 5 moles per liter (M), such as from 0.1 to 2 M, including from 0.5 to 3 M, divalent cations, such as calcium (Ca²⁺) at a concentration ranging from 0.05 to 2 moles per liter (M), such as from 0.1 to 1 M, including from 0.2 to 1 M, divalent cations, such as magnesium (Mg²⁺) at a concentration ranging from 0.001 to 1 moles per liter (M), such as from 0.005 to 0.1 M, including from 0.01 to 0.5 M, divalent anions, such as sulfate (SO₄²⁻) at a concentration ranging from 0.001 to 1 moles per liter (M), such as from 0.005 to 0.1 M, including from 0.01 to 0.5 M.

Aspects of the methods further include contacting the regenerated aqueous capture ammonia with a gaseous source of CO₂, e.g., as described above, under conditions sufficient to produce a CO₂ sequestering carbonate, e.g., as described above. In other words, the methods include recycling the regenerated ammonia into the process. In such instances, the regenerated aqueous capture ammonia may be used as the sole capture liquid, or combined with another liquid, e.g., make up water, to produce an aqueous capture ammonia suitable for use as a CO₂ capture liquid. Where the regenerated aqueous ammonia is combined with additional water, any convenient water may be employed. Waters of interest from which the aqueous capture ammonia may be produced include, but are not limited to, freshwaters, seawaters, brine waters, produced waters and waste waters.

In some embodiments an additive is present in the cation source and/or in the aqueous ammonia capture liquid regenerated from the aqueous ammonium salt. Additives may include, e.g., ionic species such as magnesium (Mg2+), strontium (Sr2+), barium (Ba²⁺), radium (Ra²⁺), ammonium (NH₄⁺), sulfate (SO₄²⁻), phosphates (PO₄³⁻, HPO₄²⁻, or H₂PO₄⁻), carboxylate groups such as, e.g., oxylate, carbamate groups such as, e.g., H₂NCOO⁻, transition metal cations such as, e.g., manganese (Mn), copper (Cu), nickel (Ni), zinc (Zn), cadmium (Cd), chromium (Cr). In some instances, the additives are intentionally added to the cation source and/or to the aqueous ammonia capture liquid regenerated from the aqueous ammonium salt. In other instances, the additives are extracted from an alkalinity source during some embodiments of the method.

### Production of Building Materials

As discussed above, methods of the invention include producing a building material. As discussed herein, a “building material” refers to a material that may be employed in the construction of a built structure. Building materials of interest include, for example, aggregates. In certain cases, methods include mineralizing carbon from the composition 110 to produce the building material. By “mineralization” it is meant that carbon (e.g., in the form of CO₂) becomes embodied in solid composition (e.g., a CO₂ embodied cement or a CO₂ embodied aggregate, etc.).

In certain cases, the building material is, or includes, an aggregate. The term “aggregate” is used in its conventional sense to refer to a granular material, i.e., a material made up of grains or particles. As the aggregate is a carbonate aggregate, the particles of the granular material include one or more carbonate compounds, where the carbonate compound(s) component may be combined with other substances (e.g., substrates) or make up the entire particles, as desired. In certain cases, methods of the invention include producing carbonate coated aggregates, e.g., for use in concretes and other applications. The carbonate coated aggregates may be conventional or lightweight aggregates. The CO₂ sequestering aggregate compositions include aggregate particles having a core and a CO₂ sequestering carbonate coating on at least a portion of a surface of the core. The CO₂ sequestering carbonate coating is made up of a CO₂ sequestering carbonate material.

In some embodiments, production of the building material involves the use of an aggregate substrate. When employed, any convenient aggregate substrate may be used. Examples of suitable aggregate substrates include, but are not limited to: natural mineral aggregate materials, e.g., rocks, sand (e.g., natural silica sand), sandstone, gravel, granite, diorite, gabbro, basalt, etc.; and synthetic aggregate materials, such as industrial byproduct aggregate materials, e.g., blast-furnace slag, fly ash, municipal waste, and recycled concrete, etc. In these instances, the aggregate substrate includes a material that is different from the particles of the composition 110. In other instances, the substrate may be the aggregate formed from the process described herein from an earlier production. In some cases, that substrate may be an agglomeration of non-carbonate particles agglomerated together with the carbonate slurry in the earlier production cycle, especially when finer core substrate grains are employed. Such agglomerated composite substrates may have certain benefits, such as having a light weight characteristic, bestowing the final aggregate with properties suitable for light weight concrete, or have a greater proportion of the aggregate comprising CO₂-sequestered carbonate, increase the CO₂ sequestration potential of the aggregate when deployed in concrete, thus lowering the embodied CO₂ of the concrete in a lifecycle analysis.

In some instances, the substrate is referred to as a seed structure. In such instances, the method may include producing carbonate material in association with the seed structure. By seed structure is meant a solid structure or material that is present in a flowing liquid, e.g., in a material production zone, prior to divalent cation introduction into the liquid”. By “in association” with “is meant that the material is produced on at least one of” a surface or in a depression, e.g., a pore, crevice, etc., of the seed structure. In such instances, a composite structure of the carbonate material and the seed structure is produced. In some instances, the product carbonate material coats a portion, if not all of, “the surface of a seed structure. In some instances, the product carbonate materials fill in a depression of the seed structure, e.g., a pore, crevice, fissure, etc.

Seed structures may vary widely as desired. The term “seed structure” is used to describe any object upon and/or in which the product carbonate material forms. Seed structures may range from singular objects or particulate compositions, as desired.

Where the seed structure is a singular object, it may have a variety of different shapes, which may be regular or irregular, and a variety of different dimensions. Shapes of interest include, but are not limited to, rods, meshes, blocks, etc. Exemplary systems and methods involving the production of carbonate coated aggregates are described in U.S. Pat. Nos. 9,993,799, 10,766,015; U.S. patent application Ser. No. 16/943,540; as well as Published PCT Application Publication No. WO 2020/154518; the disclosures of which are herein incorporated by reference.

In some instances, the seed structure is a particulate composition, e.g., granular composition, made up of a plurality of particles. Where the seed structure is a particulate composition, the dimensions of particles making up the seed structure may vary, ranging in some instances from 0.01 to 1,000,000 μm, such as 0.1 to 100,000 μm. The number of particles in the seed structure may also vary, ranging in some instances from 5 to 5 trillion, such as 50 to 1 trillion, e.g., 100 to 100 billion, etc., where in some instances the number of particles making up the seed structure is 1,000 or more, such as 10,000 or more, including 100,000 or more, e.g., 1,000,000 or more.

In some instances, seed structure may be coarse aggregates, such as friable Pleistocene coral rock, e.g., as may be obtained from tropical areas (e.g., Florida) that are too weak to serve as aggregate for concrete. In this case the friable coral rock can be used as a seed, and the solid CO₂ sequestering carbonate mineral may be deposited in the internal pores, making the coarse aggregate suitable for use in concrete, allowing it to pass the LA Rattler abrasion test. In some instances, where a lightweight aggregate is desired, the outer surface will only be penetrated by the solution of deposition, leaving the inner core relatively ‘hollow’ making a lightweight aggregate for use in light weight concrete.

In some embodiments, a carbonate composition 110 comprising ACC and structural water is introduced into a revolving drum and subjected to rotational action (e.g., mixed) in the revolving drum under conditions sufficient to produce a carbonate aggregate. Methods of producing an aggregate involving subjecting a carbonate slurry to rotational action are described in, for example, U.S. patent application Ser. No. 17/297,278 filed on May 26, 2021, and published as US 2021-0403336 A1 (Attorney docket no. BLUE-044), the disclosure of which is incorporated by reference herein.

The composition 110, and aggregate substrate when present, is mixed in the revolving drum for a period of time sufficient to produce the desired carbonate aggregate. While the period of time may vary, in some instances the period of time ranges from 10 min to 5 hours, such as 15 min to 3 hours or more.

During and/or following mixing, the resultant carbonate aggregate may be dried. Where desired, drying may be achieved using any convenient protocol. In some instances, drying the resultant carbonate aggregate may occur during production, e.g., by application of heat during mixing. Such protocols include, e.g., direct heating of the mixing vessel, e.g., using waste energy to supply the heat, or, e.g., heating the inside of the mixing vessel with, e.g., hot flue gas from a fossil fuel combustion process, so that the temperature of the internal atmosphere where the carbonate aggregate is being produced is between 15° C. and 260° C., or between 15° C. and 30° C., or 15° C. and 50° C., or 15° C. and 200° C., or between or 20° C. and 200° C., such as 20° C. and 60° C., or 25° C. and 75° C., or 25° C. and 150° C., or between 30° C. and 250° C., such as 30° C. and 150° C., or 30° C. and 200° C., and including between 40° C. and 250° C., to dry the carbonate aggregate. In other instances, drying the resultant carbonate aggregate may occur after production, e.g., after the aggregate has exited the mixing and/or aggregate production vessel. Convenient protocols include drying the resultant carbonate aggregate in open atmosphere under ambient conditions, e.g., outside in an aggregate storage bay and/or silo at a production plant or, e.g., in a covered dome or enclosed container away from outside elements. In some instances of the embodiment, the method of drying may include curing the resultant aggregate, e.g., as described below. In other instances of the embodiment, the method may not involve drying the resultant carbonate aggregate.

Where the composition 110 is mixed with an aggregate substrate in a revolving drum, the resultant carbonate aggregate is a carbonate coated aggregate, where the particulate members of the aggregate include a core material at least partially, if not completely, coated by a carbonate material. In some cases, especially with finer core grains, the carbonate slurry binds more than one particle of core material together into an agglomerated composite.

Where desired, the methods may include curing the resultant carbonate building material (e.g., aggregate). As used herein, “curing” means altering the structural composition of a compound. In some cases, curing includes changing a compound in an initial CO₂ sequestering solid composition (e.g., a precipitate or aggregate composition) from a first polymorph to a second polymorph. Methods of curing an aggregate product are described in, for example, U.S. Provisional Patent Application Ser. No. 63/128,487, the disclosure of which is incorporated by reference in its entirety. Accordingly, embodiments of the invention include contacting the building material (e.g., aggregate) with a curing liquid sufficient to produce a cured building material. The curing liquid is a composition that can be contacted with the initial CO₂ sequestering composition, thereby curing it and producing a cured CO₂ sequestering solid. The term “liquid” in “curing liquid” means that the curing composition includes a compound in a liquid state of matter, e.g., water. For example, the curing liquid can be an aqueous liquid wherein water is the most abundant compound present in the curing liquid. In certain cases, the curing liquid may be chosen from a carbonate curing liquid, a bicarbonate curing liquid, a phosphate curing liquid, a divalent alkali earth metal curing liquid tap water, or a combination thereof. In some versions, the curing liquid is substantially free or completely free of any compounds dissolved in the water of the aqueous curing liquid. In other embodiments, the curing liquid includes water and compounds dissolved in the water, i.e., the curing liquid is a solution that includes solutes dissolved in a solvent. In some cases, the curing liquid also includes a compound in a solid state of matter, i.e., a solid compound that is not dissolved in the liquid. In some embodiments the curing liquid is an emulsion, i.e., it is a mixture of two or more liquids that normally form two immiscible layers, but wherein addition of an emulsifier causes the two layers to merge and form a single layer.

In some cases, the curing step includes changing a compound of the initial CO₂ sequestering composition from a first crystal structure to a second crystal structure, wherein the curing compound permits or increases the rate of this change. In some instances, the curing liquid allows for the temporary dissolution of solid compounds into the curing liquid, followed by a transition of these compounds back into a solid state, but in a second crystal structure. In some cases, the curing liquid favors the formation of the second crystal structure over formation of the first crystal structure. In some embodiments, the curing liquid includes an ion, e.g., carbonate, that is also present in the initial CO₂ sequestering composition. Due to limitation on solubility, the presence of this ion in the curing liquid can help prevent an undesirably high amount of the initial CO₂ sequestering composition from dissolving in the curing liquid and remaining in the curing liquid. In other words, the presence of this common ion can favor the transition of the compound back into a solid state, but in the second crystal structure. In other cases, the curing compound can directly interact with the solid in the first crystal structure and cause it to change into the second crystal structure without dissolving into the curing liquid.

In other embodiments, the curing happens because the curing compound changes the pH of the initial CO₂ sequestering solid composition. In other words, the curing liquid can have a pH that causes the protonation or deprotonation of compounds within the initial CO₂ sequestering solid composition. In some cases, the curing process happens because some solid compounds of the initial CO₂ sequestering solid composition become dissolved in the curing liquid, thereby separating them from the sequestering solid. The curing liquid can also contain compounds that transition from dissolved in the curing liquid to the solid state, thereby becoming part of the sequestering solid.

In some cases, the curing liquid has a dissolved inorganic carbon concentration sufficient to produce the desired cured composition. Dissolved inorganic carbon (DIC) refers to carbonate ions (CO₃²⁻), bicarbonate ions (HCO₃), and CO₂ dissolved in a liquid. In some instances, the curing liquid has a DIC ranging from 0.01 M to 10 M, such as from 0.05 M to 5 M, 0.1 M to 4 M, or 0.5 M to 3 M. For example, if the curing liquid includes 1 M of carbonate ions, 0.2 M of bicarbonate ions, and 0.1 M of dissolved CO₂, then the dissolved inorganic carbon concentration will be 1.3 M. In some cases, the curing liquid has concentration of positive ions ranging from 0.01 M to 10 M, such as from 0.05 M to 5 M, 0.1 M to 4 M, or 0.5 M to 3 M, e.g., wherein the positive ion is selected from the group consisting of Na⁺, K⁺, and NH₄⁺. For example, in some cases the curing liquid has a concentration of Na⁺ ions ranging from 0.5 M to 5 M.

In some cases, the curing liquid comprises a carbonate curing liquid, i.e., the liquid includes a carbonate compound including the carbonate ion (CO₃²⁻), a bicarbonate compound including the bicarbonate ion (HCO₃²⁻), or both. In some cases, the carbonate compound has the formula M₂CO₃, wherein M is a monovalent positive ion, e.g., an alkali metal cation. For example, the carbonate compound can be sodium carbonate (Na₂CO₃), ammonium carbonate ((NH₄)₂CO₃), or potassium carbonate (K₂CO₃). In some cases, the curing liquid includes a bicarbonate compound, e.g., of the formula MHCO₃, wherein M is a monovalent position ion, e.g., an alkali metal cation. Exemplary bicarbonate compounds include sodium bicarbonate (NaHCO₃), ammonium bicarbonate (NH₄HCO₃), and potassium bicarbonate (K₂HCO₃).

In some instances, the curing liquid is a phosphate curing liquid, i.e., it can include a phosphate compound. As used herein, “phosphate” refers to a compound that includes four oxygen atoms bonded to a phosphorous atom, i.e., a compound that includes a phosphate group. In some cases, the phosphate compound has the formula PO₄R¹R²R³, wherein R¹, R², and R³ are each independently hydrogen or a negative charge. When R¹, R², and R³ are all a hydrogen atom then the compound is H₃PO₄, which is referred to as phosphoric acid herein. When R¹ and R² are hydrogen and R³ is a negative charge, the resulting compound is H₂PO₄⁻, which is referred to herein as the dihydrogen phosphate ion, and the curing liquid has a corresponding positive ion, such as an alkali metal cation, e.g., Na⁺ or K⁺. When R¹ is hydrogen and R² and R³ are negative charges, the resulting compound is HPO₄²⁻, which is referred to herein as the hydrogen phosphate ion, and the curing liquid has corresponding positive ion or ions. When R¹, R², and R³ are all negative charges then the compound is PO₄³⁻, which is referred to herein as the phosphate ion, and the curing liquid has corresponding positive ion or ions. The phosphate curing liquid can also include a polyphosphate group, i.e., a group having two or more phosphorous atoms which are each bonded to four oxygen atoms, wherein one of the oxygen atoms is bonded to two phosphorous atoms. An exemplary polyphosphate compound is polyphosphoric acid, which has the formula HO—(PO₃H)ₙ—H, wherein n is an integer of 2 or more, such as from 2 to 10,000. In some cases, the polyphosphate is deprotonated, i.e., wherein one or more of the hydrogen atoms are replaced with negative charges, and the curing liquid includes corresponding positive ions, e.g., alkali metal cations such as Na⁺ and K⁺. In some cases, the phosphate compound is an organophosphate compound, i.e., has the formula PO₄R¹R²R³, wherein R¹, R², and R³ are each independently hydrogen, a hydrocarbon group, or negative charge, wherein at least one of R¹, R², and R³ is a hydrocarbon group.

In some cases, the curing liquid is a divalent alkali earth metal, e.g., calcium, magnesium, etc., curing liquid, such as a calcium curing liquid, i.e., it can include divalent alkali earth metal ions, e.g., calcium ions (Ca²⁺) magnesium ions (Mg²⁺), etc. In some instances, the divalent alkali earth metal, e.g., calcium, curing liquid has a divalent alkali earth metal, e.g., calcium ion concentration ranging from 0.01 M to 1.0 M, such as from 0.02 M to 0.2 M, or 0.09 M to 0.9 M. Such curing liquids may vary, as desired, so long as they provide a source of divalent alkali earth ion, where examples of such curing liquids include, but are not limited to, CaCl₂, MgCl₂, etc. In some cases where the curing liquid is a calcium curing liquid, the calcium curing liquid is supersaturated with Ca²⁺ and DIC, wherein additional CO₂ sequestering solid is formed. For example, if the curing liquid is the filtrate from preparing the initial CO₂ sequestering solid composition from a method that comprises contacting an aqueous capture liquid comprising a cation source with a gaseous source of CO₂ under conditions sufficient to produce the initial CO₂ sequestering solid.

In some cases, the curing liquid includes tap water, i.e., the curing liquid includes water obtained from a municipal water supply. The term “municipal water supply” refers to potable water (i.e., drinking water) that is regarded as safe for humans to drink and that is delivered by pipes to two or more businesses or homes, such as 100 or more businesses or homes. In some cases, the curing liquid comprises a combination of any of the abovementioned curing liquids, i.e., a composite curing liquid comprised of bicarbonate curing liquid, carbonate curing liquid, phosphate curing liquid, alkali earth metal, e.g., calcium, curing liquid and tap water, or any composite combination thereof.

Where the carbonate coating is produced using a CO₂ sequestering process, e.g., as described above, the resultant aggregate compositions may be considered to be CO₂ sequestering aggregate compositions. In some instances, the CO₂ sequestering aggregate compositions include aggregate particles having a core and a CO₂ sequestering carbonate coating on at least a portion of a surface of the core. The CO₂ sequestering carbonate coating is made up of a CO₂ sequestering carbonate material. By “CO₂ sequestering carbonate material” is meant a material that stores a significant amount of CO₂ in a storage-stable format, such that CO₂ gas is not readily produced from the material and released into the atmosphere. In certain embodiments, the CO₂-sequestering material includes 5% or more, such as 10% or more, including 25% or more, for instance 50% or more, such as 75% or more, including 90% or more of CO₂, e.g., present as one or more carbonate compounds. In additional embodiments, the CO₂-sequestering material may form independent particles without a substrate particle. The CO₂-sequestering materials present in coatings in accordance with the invention may include one or more carbonate compounds. The amount of carbonate in the CO₂-sequestering material, e.g., as determined by coulometry, may be 10% or higher, 20% or higher 40% or higher, such as 70% or higher, including 80% or higher, such as 100% when the particle form without a core substrate, or the core substrate is a particle that formed without a core substrate.

### Methods of Producing Compositions Including Building Materials

Aspects of the invention further include the production of compositions including building materials (e.g., aggregates) of the invention. In some embodiments, the subject compositions are settable compositions. Settable compositions of the invention, such as concretes and mortars, are produced by combining a hydraulic cement with an amount of aggregate (e.g., such as those produced as described above) and water, either at the same time or by pre-combining the cement with aggregate, and then combining the resultant dry components with water. The liquid phase, e.g., aqueous fluid, with which the dry component (i.e., concrete dry composite) is combined to produce the settable composition, e.g., concrete, may vary, from pure water to water that includes one or more solutes, additives, co-solvents, etc., as desired. The ratio of dry component to liquid phase that is combined in preparing the settable composition may vary, and in certain embodiments ranges from 2:10 to 7:10, such as 3:10 to 6:10 and including 4:10 to 6:10.

The term “cement” as used herein refers to a particulate composition that sets and hardens after being combined with a setting fluid, e.g., an aqueous solution, such as water. The particulate composition that makes up a given cement may include particles of various sizes. In some instances, a given cement may be made up of particles having a longest cross-sectional length (e.g., diameter in a spherical particle) that ranges from 1 nm to 100 μm, such as 10 nm to 20 μm and including 15 nm to 10 μm. Cements of interest include hydraulic cements. The term “hydraulic cement” as used herein refers to a cement that, when mixed with a setting fluid, hardens due to one or more chemical reactions that are independent of the water content of the mixture and are stable in aqueous environments. As such, hydraulic cements can harden underwater or when constantly exposed to wet weather conditions. Hydraulic cements of interest include, but are not limited to Portland cements, modified Portland cements, and blended hydraulic cements.

Following the combination of the components to produce settable compositions (e.g., concrete), the settable compositions are in some instances initially flowable compositions, and then set after a given period of time. The setting time may vary, and in certain embodiments ranges from 30 minutes to 48 hours, such as 30 minutes to 24 hours and including from 1 hour to 4 hours.

The components of the settable composition can be combined using any convenient protocol. Each material may be mixed at the time of work, or part of or all of the materials may be mixed in advance. Alternatively, some of the materials are mixed with water with or without admixtures, such as high-range water-reducing admixtures, and then the remaining materials may be mixed therewith. As a mixing apparatus, any conventional apparatus can be used. For example, Hobart mixer, slant cylinder mixer, Omni Mixer, Henschel mixer, V-type mixer, and Nauta mixer can be employed.

In some embodiments, the production of the subject settable compositions includes the addition of admixtures. “Admixtures” are referred to in their conventional sense to describe substances other than cement, water and aggregate that are added to produce a settable composition (e.g., concrete). Admixtures may, in some cases, be added to confer a desired property to the settable composition (e.g., corrosion resistance, hydration control, etc.). Admixtures of interest include finely divided mineral admixtures such as cementitious materials; pozzolans; pozzolanic and cementitious materials; and nominally inert materials. Pozzolans include diatomaceous earth, opaline cherts, clays, shales, fly ash, silica fume, volcanic tuffs and pumicites are some of the known pozzolans. Certain ground granulated blast-furnace slags and high calcium fly ashes possess both pozzolanic and cementitious properties. Nominally inert materials can also include finely divided raw quartz, dolomites, limestone, marble, granite, and others. Fly ash is defined in ASTM C618. Other types of admixture of interest include plasticizers, accelerators, retarders, air-entrainers, foaming agents, water reducers, corrosion inhibitors, and pigments. As such, admixtures of interest include, but are not limited to: set accelerators, set retarders, air-entraining agents, defoamers, alkali-reactivity reducers, bonding admixtures, dispersants, coloring admixtures, corrosion inhibitors, dampproofing admixtures, gas formers, permeability reducers, pumping aids, shrinkage compensation admixtures, fungicidal admixtures, germicidal admixtures, insecticidal admixtures, rheology modifying agents, finely divided mineral admixtures, pozzolans, aggregates, wetting agents, strength enhancing agents, water repellents, and any other concrete or mortar admixture or additive. Admixtures are well-known in the art and any suitable admixture of the above type or any other desired type may be used; see, e.g., U.S. Pat. No. 7,735,274 , incorporated herein by reference in its entirety.

Methods of interest may additionally include producing concrete dry composites that, upon combination with a suitable setting liquid, produce a settable composition that sets and hardens into a concrete or a mortar. Concrete dry composites as described herein include an amount of an aggregate (e.g., CO₂ sequestering aggregate, produced as described above), and a cement, such as a hydraulic cement. The setting and hardening of the product produced by combination of the concrete dry composites of the invention with an aqueous liquid are a result of the production of hydrates that are formed from the cement upon reaction with water, where the hydrates are essentially insoluble in water.

Also of interest are formed building materials. Formed building materials of interest include a building material (e.g., an aggregate) of the invention. The formed building materials of the invention may vary greatly. By “formed” is meant shaped, e.g., molded, cast, cut or otherwise produced, into a man-made structure defined physical shape, i.e., configuration. Formed building materials are distinct from amorphous building materials, e.g., particulate (such as powder) compositions that do not have a defined and stable shape, but instead conform to the container in which they are held, e.g., a bag or other container. Illustrative formed building materials include, but are not limited to: bricks; boards; conduits; beams; basins; columns; drywalls etc. Further examples and details regarding formed building materials include those described in U.S. Pat. No. 8,431,100; the disclosure of which is herein incorporated by reference.

In some embodiments, the formed building material may include one or more different carbonate compounds, such as two or more different carbonate compounds, e.g., three or more different carbonate compounds, five or more different carbonate compounds, etc., including non-distinct, amorphous carbonate compounds. Carbonate compounds may be compounds having a molecular formulation Xₘ(CO₃)ₙ where X is any element or combination of elements that can chemically bond with a carbonate group or its multiple, wherein X is in certain embodiments an alkaline earth metal and not an alkali metal; wherein m and n are stoichiometric positive integers. These carbonate compounds may have a molecular formula of Xₘ(CO₃)ₙ□H₂O, where there are one or more structural waters in the molecular formula. The amount of carbonate in the formed building material, e.g., as determined by coulometry using the protocol described as coulometric titration, may be 10% or more, such as 25% or more, 50% or more, including 60% or more.

Methods of the invention may additionally include constructing a built structure using the building materials described herein. The built structure may be any structure in which a building material may be used, such as a building, dam, levee, roadway or any other manmade structure that incorporates an aggregate, rock, or settable composition. The built structure may be constructed via any suitable method using techniques that are known to those of skill in the art of construction.

### Building Materials Produced by the Methods

As reviewed above, the methods of the invention may be employed to produce building materials such as carbonate coated aggregates, e.g., for use in concretes and other applications. The carbonate coated aggregates may be conventional or lightweight aggregates. Aspects of the invention include CO₂ sequestering aggregate compositions. The CO₂ sequestering aggregate compositions include aggregate particles having a core and a CO₂ sequestering carbonate coating on at least a portion of a surface of the core. The CO₂ sequestering carbonate coating is made up of a CO₂ sequestering carbonate material, e.g., as described above.

The CO₂ sequestering carbonate material that is present in coatings of the coated particles of the subject aggregate compositions may vary. In some instances, the carbonate material is a highly reflective microcrystalline/amorphous carbonate material. As the materials may be highly reflective, the coatings that include the same may have a high total surface reflectance (TSR) value. TSR may be determined using any convenient protocol, such as ASTM E1918 Standard Test Method for Measuring Solar Reflectance of Horizontal and Low-Sloped Surfaces in the Field (see also R. Levinson, H. Akbari, P. Berdahl, Measuring solar reflectance—Part II: review of practical methods, LBNL 2010).

In some instances, the coatings that include the carbonate materials are highly reflective of near infra-red (NIR) light, ranging in some instances from 10 to 99%, such as 50 to 99%. By NIR light is meant light having a wavelength ranging from 700 nanometers (nm) to 2.5 mm. NIR reflectance may be determined using any convenient protocol, such as ASTM-1371-04a(2010)e1 Standard Test Method for Determination of Emittance of Materials Near Room Temperature Using Portable Emissometers (http://www(dot)astm(dot)org/Standards/C1371(dot)htm) or ASTM-G173-03(2012) Standard Tables for Reference Solar Spectral Irradiances: Direct Normal and Hemispherical on 37° Tilted Surface http://rredc(dot)nrel(dot)gov/solar/spectra/am1(dot)5/ASTMG173/ASTMG173(dot)html). In some instances, the coatings exhibit a NIR reflectance value ranging from Rg;0=0.0 to Rg;0=1.0, such as Rg;0=0.25 to Rg;0=0.99, including Rg;0=0.40 to Rg;0=0.98, e.g., as measured using the protocol referenced above.

In some instances, the carbonate coatings are highly reflective of ultra-violet (UV) light, ranging in some instances from 10 to 99%, such as 50 to 99%. By UV light is meant light having a wavelength ranging from 400 nm and 10 nm. UV reflectance may be determined using any convenient protocol, such as ASTM-G173-03(2012) Standard Tables for Reference Solar Spectral Irradiances: Direct Normal and Hemispherical on 37° Tilted Surface. In some instances, the materials exhibit a UV value ranging from Rg;0=0.0 to Rg;0=1.0, such as Rg;0=0.25 to Rg;0=0.99, including Rg;0=0.4 to Rg;0=0.98, e.g., as measured using the protocol referenced above.

In some instances, the coatings are reflective of visible light, e.g., where reflectivity of visible light may vary, ranging in some instances from 10 to 99%, such as 10 to 90%. By visible light is meant light having a wavelength ranging from 380 nm to 740 nm. Visible light reflectance properties may be determined using any convenient protocol, such as ASTM-G173-03(2012) Standard Tables for Reference Solar Spectral Irradiances: Direct Normal and Hemispherical on 37° Tilted Surface. In some instances, the coatings exhibit a visible light reflectance value ranging from Rg;0=0.0 to Rg;0=1.0, such as Rg;0=0.25 to Rg;0=0.99, including Rg;0=0.4 to Rg;0=0.98, e.g., as measured using the protocol referenced above.

The materials making up the carbonate components are, in some instances, amorphous or microcrystalline. Where the materials are microcrystalline, the crystal size, e.g., as determined using the Scherrer equation applied to the FWHM of X-ray diffraction pattern, is small, and in some instances is 1000 microns or less in diameter, such as 100 microns or less in diameter, and including 10 microns or less in diameter. In some instances, the crystal size ranges in diameter from 1000 μm to 0.001 μm, such as 10 to 0.001 μm, including 1 to 0.001 μm. In some instances, the crystal size is chosen in view of the wavelength(s) of light that are to be reflected. For example, where light in the visible spectrum is to be reflected, the crystal size range of the materials may be selected to be less than one-half the “to be reflected” range, so as to give rise to photonic band gap. For example, where the to be reflected wavelength range of light is 100 to 1000 nm, the crystal size of the material may be selected to be 50 nm or less, such as ranging from 1 to 50 nm, e.g., 5 to 25 nm. In some embodiments, the materials produced by methods of the invention may include rod-shaped crystals and amorphous solids. The rod-shaped crystals may vary in structure, and in certain embodiments have length to diameter ratio ranging from 500 to 1, such as 10 to 1. In certain embodiments, the length of the crystals ranges from 0.5 μm to 500 μm, such as from 5 μm to 100 μm. In yet other embodiments, substantially completely amorphous solids are produced.

The density, porosity, and permeability of the coating materials may vary according to the application. With respect to density, while the density of the material may vary, in some instances the density ranges from 5 g/cm³ to 0.01 g/cm³, such as 3 g/cm³ to 0.3 g/cm³ and including 2.7 g/cm³ to 0.4 g/cm³. With respect to porosity, as determined by Gas Surface Adsorption as determined by the BET method (Brown Emmett Teller (e.g., as described in E. Teller, J. Am. Chem. Soc., 1938, 60, 309. doi:10.1021/ja01269a023) the porosity may range in some instances from 100 m²/g to 0.1 m²/g, such as 60 m² /g to 1 m²/g and including 40 m²/g to 1.5 m² /g. With respect to permeability, in some instances the permeability of the material may range from 0.1 to 100 darcies, such as 1 to 10 darcies, including 1 to 5 darcies (e.g., as determined using the protocol described in H. Darcy, Les Fontaines Publiques de la Ville de Dijon, Dalmont, Paris (1856).). Permeability may also be characterized by evaluating water absorption of the material. As determined by water absorption protocol, e.g., the water absorption of the material ranges, in some embodiments, from 0 to 25%, such as 1 to 15% and including from 2 to 9%.

The hardness of the materials may also vary. In some instances, the materials exhibit a Mohs hardness of 3 or greater, such as 5 or greater, including 6 or greater, where the hardness ranges in some instances from 3 to 8, such as 4 to 7 and including 5 to 6 Mohs (e.g., as determined using the protocol described in American Federation of Mineralogical Societies. “Mohs Scale of Mineral Hardness”). Hardness may also be represented in terms of tensile strength, e.g., as determined using the protocol described in ASTM C1167. In some such instances, the material may exhibit a compressive strength of 100 to 3000 N, such as 400 to 2000 N, including 500 to 1800 N.

In some embodiments, the carbonate material includes one or more contaminants predicted not to leach into the environment by one or more tests selected from the group consisting of Toxicity Characteristic Leaching Procedure, Extraction Procedure Toxicity Test, Synthetic Precipitation Leaching Procedure, California Waste Extraction Test, Soluble Threshold Limit Concentration, American Society for Testing and Materials Extraction Test, and Multiple Extraction Procedure. Tests and combinations of tests may be chosen depending upon likely contaminants and storage conditions of the composition. For example, in some embodiments, the composition may include As, Cd, Cr, Hg, and Pb (or products thereof), each of which might be found in a waste gas stream of a coal-fired power plant. Since TCLP tests for As, Ba, Cd, Cr, Pb, Hg, Se, and Ag, TCLP may be an appropriate test for aggregates described herein. In some embodiments, a carbonate composition of the invention includes As, wherein the composition is predicted not to leach As into the environment. For example, a TCLP extract of the composition may provide less than 5.0 mg/L As indicating that the composition is not hazardous with respect to As. In some embodiments, a carbonate composition of the invention includes Cd, wherein the composition is predicted not to leach Cd into the environment. For example, a TCLP extract of the composition may provide less than 1.0 mg/L Cd indicating that the composition is not hazardous with respect to Cd. In some embodiments, a carbonate composition of the invention includes Cr, wherein the composition is predicted not to leach Cr into the environment. For example, a TCLP extract of the composition may provide less than 5.0 mg/L Cr indicating that the composition is not hazardous with respect to Cr. In some embodiments, a carbonate composition of the invention includes Hg, wherein the composition is predicted not to leach Hg into the environment. For example, a TCLP extract of the composition may provide less than 0.2 mg/L Hg indicating that the composition is not hazardous with respect to Hg. In some embodiments, a carbonate composition of the invention includes Pb, wherein the composition is predicted not to leach Pb into the environment. For example, a TCLP extract of the composition may provide less than 5.0 mg/L Pb indicating that the composition is not hazardous with respect to Pb. In some embodiments, a carbonate composition and aggregate that includes of the same of the invention may be non-hazardous with respect to a combination of different contaminants in a given test. For example, the carbonate composition may be non-hazardous with respect to all metal contaminants in a given test. A TCLP extract of a composition, for instance, may be less than 5.0 mg/L in As, 100.0 mg/L in Ba, 1.0 mg/L in Cd, 5.0 mg/mL in Cr, 5.0 mg/L in Pb, 0.2 mg/L in Hg, 1.0 mg/L in Se, and 5.0 mg/L in Ag. Indeed, a majority if not all of the metals tested in a TCLP analysis on a composition of the invention may be below detection limits. In some embodiments, a carbonate composition of the invention may be non-hazardous with respect to all (e.g., inorganic, organic, etc.) contaminants in a given test. In some embodiments, a carbonate composition of the invention may be non-hazardous with respect to all contaminants in any combination of tests selected from the group consisting of Toxicity Characteristic Leaching Procedure, Extraction Procedure Toxicity Test, Synthetic Precipitation Leaching Procedure, California Waste Extraction Test, Soluble Threshold Limit Concentration, American Society for Testing and Materials Extraction Test, and Multiple Extraction Procedure. As such, carbonate compositions and aggregates including the same of the invention may effectively sequester CO₂ (e.g., as carbonates, bicarbonates, or a combination thereof) along with various chemical species (or co-products thereof) from waste gas streams, industrial waste sources of divalent cations, industrial waste sources of proton-removing agents, or combinations thereof that might be considered contaminants if released into the environment.

Compositions of the invention incorporate environmental contaminants (e.g., metals and co-products of metals such as Hg, Ag, As, Ba, Be, Cd, Co, Cr, Cu, Mn, Mo, Ni, Pb, Sb, Se, TI, V, Zn, or combinations thereof) in a non-leachable form.

The aggregate compositions of the invention include particles having a core region and a CO₂ sequestering carbonate coating on at least a portion of a surface of the core. The coating may cover 10% or more, 20% or more, 30% or more, 40% or more, 50% or more, 60% or more, 70% or more, 80% or more, 90% or more, including 95% or more of the surface of the core. The thickness of the carbonate layer may vary, as desired. In some instances, the thickness may range from 0.1 μm to 10 mm, such as 1 μm to 1000 μm, including 10 μm to 500 μm.

The core of the coated particles of the aggregate compositions described herein may vary widely. The core may be made up of any convenient aggregate material. Examples of suitable aggregate materials include, but are not limited to: natural mineral aggregate materials, e.g., carbonate rocks, sand (e.g., natural silica sand), sandstone, gravel, granite, diorite, gabbro, basalt, etc.; and synthetic aggregate materials, such as industrial byproduct aggregate materials, e.g., blast-furnace slag, fly ash, municipal waste, and recycled concrete, etc. In some instances, the core comprises a material that is different from the carbonate coating.

In some instances, the aggregates are lightweight aggregates. In such instances, the core of the coated particles of the aggregate compositions described herein may vary widely, so long as when it is coated it provides for the desired lightweight aggregate composition. The core may be made up of any convenient material. Examples of suitable aggregate materials include, but are not limited to: conventional lightweight aggregate materials, e.g., naturally occurring lightweight aggregate materials, such as crushed volcanic rocks, e.g., pumice, scoria or tuff, and synthetic materials, such as thermally treated clays, shale, slate, diatomite, perlite, vermiculite, blast-furnace slag and fly ash; as well as unconventional porous materials, e.g., crushed corals, synthetic materials like polymers and low density polymeric materials, recycled wastes such as wood, fibrous materials, cement kiln dust residual materials, recycled glass, various volcanic minerals, granite, silica bearing minerals, mine tailings and the like.

The physical properties of the coated particles of the aggregate compositions may vary. Aggregates of the invention have a density that may vary so long as the aggregate provides the desired properties for the use for which it will be employed, e.g., for the building material in which it is employed. In certain instances, the density of the aggregate particles ranges from 1.1 to 5 gm/cc, such as 1.3 gm/cc to 3.15 gm/cc, and including 1.8 gm/cc to 2.7 gm/cc. Other particle densities in embodiments of the invention, e.g., for lightweight aggregates, may range from 1.1 to 2.2 gm/cc, e.g., 1.2 to 2.0 g/cc or 1.4 to 1.8 g/cc. In some embodiments the invention provides aggregates that range in bulk density (unit weight) from 50 lb/lb/ft³ to 200 lb/ft³, or 75 lb/ft³ to 175 lb/ft³ , or 50 lb/ft³ to 100 lb/ft³, or 75 lb/ft³ to 125lb/ft³ , or lb/ft³ to 115 lb/ft³ , or 100 lb/ft³ to 200 lb/ft³, or 125 lb/ft³ to lb/ft³, or 140 lb/ft³ to 160 lb/ft³, or 50 lb/ft³ to 200 lb/ft³. Some embodiments of the invention provide lightweight aggregate, e.g., aggregate that has a bulk density (unit weight) of 75 lb/ft³ to 125 lb/ft³, such as 90 lb/ft³ to 115 lb/ft³. In some instances, the lightweight aggregates have a weight ranging from 50 to 1200 kg/m³, such as 80 to 11 kg/m³.

The hardness of the aggregate particles making up the aggregate compositions of the invention may also vary, and in certain instances the hardness, expressed on the Mohs scale, ranges from 1.0 to 9, such as 1 to 7, including 1 to 6 or 1 to 5. In some embodiments, the Mohr's hardness of aggregates of the invention ranges from 2-5, or 2-4. In some embodiments, the Mohs hardness ranges from 2-6. Other hardness scales may also be used to characterize the aggregate, such as the Rockwell, Vickers, or Brinell scales, and equivalent values to those of the Mohs scale may be used to characterize the aggregates of the invention; e.g., a Vickers hardness rating of 250 corresponds to a Mohs rating of 3; conversions between the scales are known in the art.

The abrasion resistance of an aggregate may also be important, e.g., for use in a roadway surface, where aggregates of high abrasion resistance are useful to keep surfaces from polishing. Abrasion resistance (i.e., abrasion value) is related to hardness but is not the same. Aggregates of the invention include aggregates that have an abrasion resistance similar to that of natural limestone, or aggregates that have an abrasion resistance superior to natural limestone, as well as aggregates having an abrasion resistance lower than natural limestone, as measured by art accepted methods, such as ASTM C131-03, the Los Angeles Abrasion Test, and the Micro Deval Test. In some embodiments aggregates of the invention have an abrasion resistance of less than 50%, or less than 40%, or less than 35%, or less than 30%, or less than 25%, or less than 20%, or less than 15%, or less than 10%, when measured by ASTM C131-03. In some embodiments aggregates of the invention have an abrasion value of less than 40%, or less than 35%, or less than 30%, or less than 25%, or less than 20%, or less than 15%, or less than 10%, when measured by the Los Angeles Abrasion Test. In some embodiments aggregates of the invention have an abrasion value of less than 25%, or less than 20%, or less than 15%, or less than 10%, when measured by the Micro Deval Test.

Aggregates of the invention may also have a porosity within particular ranges. As will be appreciated by those of skill in the art, in some cases a highly porous aggregate is desired, in others an aggregate of moderate porosity is desired, while in other cases aggregates of low porosity, or no porosity, are desired. Porosities of aggregates of some embodiments of the invention, as measured by water uptake after oven drying followed by full immersion for 60 minutes, expressed as % dry weight, can be in the range of 1-40%, such as 2-20%, or 2-15%, including 2-10% or even 3-9%.

The dimensions of the aggregate particles may vary. Aggregate compositions of the invention are particulate compositions that may in some embodiments be classified as fine or coarse. Fine aggregates according to embodiments of the invention are particulate compositions that almost entirely pass through a Number 4 sieve (ASTM C 125 and ASTM C 33). Fine aggregate compositions according to embodiments of the invention have an average particle size ranging from 10 μm to 4.75 mm, such as 50 μm to 3.0 mm and including 75 μm to 2.0 mm. Coarse aggregates of the invention are compositions that are predominantly retained on a Number 4 sieve (ASTM C 125 and ASTM C 33). Coarse aggregate compositions according to embodiments of the invention are compositions that have an average particle size ranging from 4.75 mm to 200 mm, such as 4.75 to 150 mm in and including 5 to 100 mm. As used herein, “aggregate” may also in some embodiments encompass larger sizes, such as 3 in to 12 in or even 3 in to 24 in, or larger, such as 12 in to 48 in, or larger than 48 in.

### Compositions Including Building Materials

Aspects of the invention also include compositions that include building materials (e.g., aggregates) of the invention. Compositions of interest include, for example, concrete dry composites, settable compositions, and built structures.

### Concrete Dry Composites

Provided herein are concrete dry composites including a building material (e.g., aggregate) of the invention, upon combination with a suitable setting liquid (such as described below), produce a settable composition that sets and hardens into a concrete or a mortar. Concrete dry composites as described herein include an amount of an aggregate, e.g., as described above, and a cement, such as a hydraulic cement. The term “hydraulic cement” is employed in its conventional sense to refer to a composition which sets and hardens after combining with water or a solution where the solvent is water, e.g., an admixture solution. The setting and hardening of the product produced by combination of the concrete dry composites of the invention with an aqueous liquid results from the production of hydrates that are formed from the cement upon reaction with water, where the hydrates are essentially insoluble in water.

Aggregates of the invention find use in place of conventional natural rock aggregates used in conventional concrete when combined with pure Portland cement. Other hydraulic cements of interest in certain embodiments are Portland cement blends. The phrase “Portland cementblend” includes a hydraulic cement composition that includes a Portland cement component and significant amount of a non-Portland cement component. As the cements of the invention are Portland cement blends, the cements include a Portland cement component. The Portland cement component may be any convenient Portland cement. As is known in the art, Portland cements are powder compositions produced by grinding Portland cement clinker (more than 90%), a limited amount of calcium sulfate which controls the set time, and up to 5% minor constituents (as allowed by various standards). When the exhaust gases used to provide carbon dioxide for the reaction contain SOx, then sufficient sulphate may be present as calcium sulfate in the precipitated material, either as a cement or aggregate to offset the need for additional calcium sulfate. As defined by the European Standard EN197.1, “Portland cement clinker is a hydraulic material which shall consist of at least two-thirds by mass of calcium silicates (3CaO.SiO₂ and 2CaO.SiO₂), the remainder consisting of aluminum- and iron-containing clinker phases and other compounds. The ratio of CaO to SiO₂ shall not be less than 2.0. The magnesium content (MgO) shall not exceed 5.0% by “mass.” The concern about MgO is that later in the setting reaction, magnesium hydroxide, brucite, may form, leading to the deformation and weakening and cracking of the cement. In the case of magnesium carbonate containing cements, brucite will not form as it may with MgO. In certain embodiments, the Portland cement constituent of the present invention is any Portland cement that satisfies the ASTM Standards and Specifications of C150 (Types I-VIII) of the American Society for Testing of Materials (ASTM C50-Standard Specification for Portland Cement). ASTM C150 covers eight types of Portland cement, each possessing different properties, and used specifically for those properties.

Also of interest as hydraulic cements are carbonate-containing hydraulic cements. Such carbonate-containing hydraulic cements, methods for their manufacture and use are described in U.S. Pat. No. 7,735,274; the disclosure of which applications are herein incorporated by reference.

In certain embodiments, the hydraulic cement may be a blend of two or more different kinds of hydraulic cements, such as Portland cement and a carbonate containing hydraulic cement. In certain embodiments, the amount of a first cement, e.g., Portland cement in the blend ranges from 10 to 90% (w/w), such as 30 to 70% (w/w) and including 40 to 60% (w/w), e.g., a blend of 80% OPC and 20% carbonate hydraulic cement.

In some instances, the concrete dry composite compositions, as well as concretes produced therefrom, have a CarbonStar Rating (CSR) that is less than the CSR of the control composition that does not include an aggregate of the invention. The Carbon Star Rating (CSR) is a value that characterizes the embodied carbon (in the form of CaCO₃) for any product, in comparison to how carbon intensive production of the product itself is (i.e., in terms of the production CO₂). The CSR is a metric based on the embodied mass of CO₂ in a unit of concrete. Of the three components in concrete—water, cement and aggregate—cement is by far the most significant contributor to CO₂ emissions, roughly 1:1 by mass (1 ton cement produces roughly 1 ton CO₂). So, if a cubic yard of concrete uses 600 lb cement, then its CSR is 600. A cubic yard of concrete according to embodiments of the present invention which include 600 lb cement and in which at least a portion of the aggregate is carbonate coated aggregate, e.g., as described above, will have a CSR that is less than 600, e.g., where the CSR may be 550 or less, such as 500 or less, including 400 or less, e.g., 250 or less, such as 100 or less, where in some instances the CSR may be a negative value, e.g., −100 or less, such as −500 or less including −1000 or less, where in some instances the CSR of a cubic yard of concrete having 600 lbs cement may range from 500 to −5000 , such as −1-0 to −4000, including −500 to −3000. To determine the CSR of a given cubic yard of concrete that includes carbonate coated aggregate of the invention, an initial value of CO₂ generated for the production of the cement component of the concrete cubic yard is determined. For example, where the yard includes 600 lbs of cement, the initial value of 600 is assigned to the yard. Next, the amount of carbonate coating in the yard is determined. Since the molecular weight of carbonate is 100 a.u., and 44% of carbonate is CO₂, the amount of carbonate coating is present in the yard is then multiplied by 0.44 and the resultant value subtracted from the initial value in order to obtain the CSR for the yard. For example, where a given yard of concrete mix is made up of 600 lbs of cement, 300 lbs of water, 1429 lbs of fine aggregate and 1739 lbs of coarse aggregate, the weight of a yard of concrete is 4068 lbs and the CSR is 600. If 10% of the total mass of aggregate in this mix is replaced by carbonate coating, e.g., as described above, the amount of carbonate present in the revised yard of concrete is 317 lbs. Multiplying this value by 0.44 yields 139.5. Subtracting this number from 600 provides a CSR of 460.5.

### Settable Compositions

Settable compositions of the invention, such as concretes and mortars, are produced by combining a hydraulic cement with an amount of an aggregate of the invention and an aqueous liquid, e.g., water, either at the same time or by pre-combining the cement with aggregate, and then combining the resultant dry components with water. The choice of coarse aggregate material for concrete mixes using cement compositions of the invention may have a minimum size of about ⅜ inch and can vary in size from that minimum up to one inch or larger, including in gradations between these limits. Finely divided aggregate is smaller than ⅜ inch in size and again may be graduated in much finer sizes down to 200-sieve size or so. Fine aggregates may be present in both mortars and concretes of the invention. The weight ratio of cement to aggregate in the dry components of the cement may vary, and in certain embodiments ranges from 1:10 to 4:10, such as 2:10 to 5:10 and including from 55:1000 to 70:100.

The liquid phase, e.g., aqueous fluid, with which the dry component is combined to produce the settable composition, e.g., concrete, may vary, from pure water to water that includes one or more solutes, additives, co-solvents, etc., as desired. The ratio of dry component to liquid phase that is combined in preparing the settable composition may vary, and in certain embodiments ranges from 2:10 to 7:10, such as 3:10 to 6:10 and including 4:10 to 6:10.

In certain embodiments, the cements may be employed with one or more admixtures. Admixtures are compositions added to concrete to provide it with desirable characteristics that are not obtainable with basic concrete mixtures or to modify properties of the concrete to make it more readily useable or more suitable for a particular purpose or for cost reduction. As is known in the art, an admixture is any material or composition, other than the hydraulic cement, aggregate and water, that is used as a component of the concrete or mortar to enhance some characteristic, or lower the cost, thereof. The amount of admixture that is employed may vary depending on the nature of the admixture. In certain embodiments the amounts of these components range from 1 to 50% w/w, such as 2 to 10% w/w.

Admixtures of interest include finely divided mineral admixtures such as cementitious materials; pozzolans; pozzolanic and cementitious materials; and nominally inert materials. Pozzolans include diatomaceous earth, opaline cherts, clays, shales, fly ash, silica fume, volcanic tuffs and pumicites are some of the known pozzolans. Certain ground granulated blast-furnace slags and high calcium fly ashes possess both pozzolanic and cementitious properties. Nominally inert materials can also include finely divided raw quartz, dolomites, limestone, marble, granite, and others. Fly ash is defined in ASTM C618. Other types of admixture of interest include plasticizers, accelerators, retarders, air-entrainers, foaming agents, water reducers, corrosion inhibitors, and pigments.

As such, admixtures of interest include, but are not limited to: set accelerators, set retarders, air-entraining agents, defoamers, alkali-reactivity reducers, bonding admixtures, dispersants, coloring admixtures, corrosion inhibitors, damp-proofing admixtures, gas formers, permeability reducers, pumping aids, shrinkage compensation admixtures, fungicidal admixtures, germicidal admixtures, insecticidal admixtures, rheology modifying agents, finely divided mineral admixtures, pozzolans, aggregates, wetting agents, strength enhancing agents, water repellents, and any other concrete or mortar admixture or additive. Admixtures are well-known in the art and any suitable admixture of the above type or any other desired type may be used; see, e.g., U.S. Pat. No. 7,735,274, incorporated herein by reference in its entirety.

In certain embodiments, settable compositions of the invention include a cement employed with fibers, e.g., where one desires fiber-reinforced concrete. Fibers can be made of zirconia containing materials, steel, carbon, fiberglass, or synthetic materials, e.g., polypropylene, nylon, polyethylene, polyester, rayon, high-strength aramid, (i.e., Kevlar®), or mixtures thereof.

The components of the settable composition can be combined using any convenient protocol. Each material may be mixed at the time of work, or part of or all of the materials may be mixed in advance. Alternatively, some of the materials are mixed with water with or without admixtures, such as high-range water-reducing admixtures, and then the remaining materials may be mixed therewith. As a mixing apparatus, any conventional apparatus can be used. For example, Hobart mixer, slant cylinder mixer, Omni Mixer, Henschel mixer, V-type mixer, and Nauta mixer can be employed.

Following the combination of the components to produce a settable composition (e.g., concrete), the settable compositions are in some instances initially flowable compositions, and then set after a given period of time. The setting time may vary, and in certain embodiments ranges from 30 minutes to 48 hours, such as 30 minutes to 24 hours and including from 1 hour to 4 hours.

The strength of the set product may also vary. In certain embodiments, the strength of the set cement may range from 5 MPa to 70 MPa, such as 10 MPa to 50 MPa and including from 20 MPa to 40 MPa. In certain embodiments, set products produced from cements of the invention are extremely durable. e.g., as determined using the test method described at ASTM C1157.

### Built Structures

Aspects of the invention further include structures produced from the aggregates and settable compositions of the invention. As such, further embodiments include manmade structures that contain the aggregates of the invention and methods of their manufacture. Thus, in some embodiments the invention provides a manmade structure that includes one or more aggregates as described herein. The manmade structure may be any structure in which an aggregate may be used, such as a building, dam, levee, roadway or any other manmade structure that incorporates an aggregate or rock. In some embodiments, the invention provides a manmade structure, e.g., a building, a dam, or a roadway, that includes an aggregate of the invention, where the aggregate may be produced from a carbonate composition comprising ACC and structural water, e.g., as described above. In some embodiments the invention provides a method of manufacturing a structure, comprising providing an aggregate of the invention.

### Utility

The subject aggregate compositions and settable compositions that include the same, find use in a variety of different applications, such as above ground stable CO₂ sequestration products, as well as building or construction materials. Specific structures in which the building materials of the invention find use include, but are not limited to: pavements, architectural structures, e.g., buildings, foundations, motorways/roads, overpasses, parking structures, brick/block walls and footings for gates, fences and poles. Mortars of the invention find use in binding construction blocks, e.g., bricks, together and filling gaps between construction blocks. Mortars can also be used to fix existing structure, e.g., to replace sections where the original mortar has become compromised or eroded, among other uses.

Methods of invention, e.g., as described above, also find use in the sequestration of CO₂, i.e., CO₂ sequestration. By “CO₂ sequestration” is meant the removal or segregation of an amount of CO₂ from CO₂ containing gas, e.g., a gaseous waste stream produced by an industrial plant, so that at least a portion of the CO₂ is no longer present in the CO₂ containing gas from which it has been removed. CO₂ sequestering methods of the invention sequester CO₂, and in some instances produce a storage stable CO₂ sequestering product from an amount of CO₂, such that the CO₂ from which the product is produced is then sequestered in that product. The storage stable CO₂ sequestering product is a storage stable composition that incorporates an amount of CO₂ into a storage stable form, such as an above-ground storage or underwater storage stable form, so that the CO₂ is no longer present as, or available to be, a gas in the atmosphere. As such, sequestering of CO₂ according to methods of the invention results in prevention of CO₂ gas from entering the atmosphere and allows for long term storage of CO₂ in a manner such that CO₂ does not become part of the atmosphere.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof.

Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

What is claimed is:

1. A composition comprising:
(1) calcium carbonate solid generated by dewatering calcium carbonate slurry that is prepared using a CO₂ sequestering process, wherein the calcium carbonate solid contains amorphous calcium carbonate (ACC) and structural water; and
(2) liquid water,
wherein the composition exhibits non-Newtonian behavior.

2. The composition of claim 1, the calcium carbonate solid comprising from 1 wt % to 100 wt % amorphous calcium carbonate (ACC) solid.

3. The composition of claim 1, the composition comprising from 55 wt % to 75 wt % calcium carbonate solid.

4. The composition of claim 1, the composition comprising about 62 wt % calcium carbonate solid.

5. The composition of claim 1, wherein the calcium carbonate solid contains vaterite.

6. The composition of claim 1, wherein the composition behaves as a solid upon being filtered.

7. The composition of claim 1, wherein the composition releases water upon application of mechanical agitation.

8. The composition of claim 7, wherein at least some of the amorphous calcium carbonate undergoes mineralogical transformation to one or more other calcium carbonate mineral polymorphs.

9. The composition of claim 7, wherein upon the release of the water, the amorphous calcium carbonate solid transforms into a calcium carbonate solid.

10. The composition of claim 9, wherein the calcium carbonate solid has a visco-elastic consistency.

11. The composition of claim 9, wherein the calcium carbonate solid has a liquid to solid ratio of about 0.5.

12. The composition of claim 9, wherein the calcium carbonate solid has a liquid to solid ratio range of about 0.4 to about 0.6.

13. The composition of claim 9, wherein the calcium carbonate solid cures to form hardened calcium carbonate aggregates.

14. The composition of claim 13, wherein the hardened calcium carbonate aggregates are cohesive when placed in water.

15. The composition of claim 13, wherein a liquid to solid ratio of the calcium carbonate solid is controlled to control pore size of the hardened calcium carbonate aggregates.

16. The composition of claim 1, wherein the CO₂ sequestering process comprises: a) contacting an aqueous capture liquid with a gaseous source of CO₂ under conditions sufficient to produce an aqueous carbonate; and then combining a cation source and the aqueous carbonate under conditions sufficient to produce a CO₂ sequestering carbonate precipitate; or b) contacting an aqueous ammonia capture liquid that includes a cation source with the gaseous source of CO₂ under conditions sufficient to produce a CO₂ sequestering carbonate.

17. A method of producing a composition as described in any of claims 1 to 16.

18. A method of producing a building material according to any of claims 1 to 16.

19. A method of constructing a built structure, the method comprising employing a building material produced according to any of claims 1 to 16 to construct the built structure.

20. An amorphous calcium carbonate comprising from 0.1 mol to 0.4 mol structural water.

21. An amorphous calcium carbonate that exhibits a single crystallization event.

22. The amorphous calcium carbonate according to claim 21, wherein the single crystallization event occurs at a temperature ranging from 510 to 535° C.

23. An amorphous calcium carbonate produced at a pH ranging from 7 to 8.

24. A composition comprising an amorphous calcium carbonate according to any of claims 20 to 23.

25. A building material produced from a composition according to claim 24.
